(19) United States
(12) Patent Application Publication
(10) Pub. No.: US 2006/0244270 A1
(43) Pub. Date: Nov. 2, 2006

(54) AUTOMATIC WINDOW TILT LATCH MECHANISM

(75) Inventor: Anthony James Rotondi, Fairfield, IA (US)

Correspondence Address: CROMPTON, SEAGER & TUFTE, LLC, 1221 NICOLLET AVENUE, SUITE 800, MINNEAPOLIS, MN, 55403-2420, US

(73) Assignee: CONTINENTAL INVESTMENT PARTNERS LLC, Wayzata, MN (US)

(21) Appl. No.: 11/160,750

(22) Filed: Jul. 7, 2005

Related U.S. Application Data
(63) Continuation-in-part of application No. 10/908,137, filed on Apr. 28, 2005.

(51) Int. Cl. E05C 3/02

(52) U.S. Cl. 292/213

(57) ABSTRACT

An automatic tilt latch mechanism for use in securing a window to a window frame is disclosed. An illustrative tilt latch mechanism in accordance with an exemplary embodiment of the present invention may include a central operator having a tilt latch actuator assembly, at least one tilt latch assembly actuatable between a locked position and an unlocked position, and a rod operatively connecting the tilt latch actuator assembly to the at least one tilt latch assembly. The central operator may comprise a stand-alone unit, or may further include a window fastener actuator assembly that can be used to lock the window sash to the window frame, if desired.

### CROSS-REFERENCE TO RELATED APPLICATIONS

The present application is a continuation-in-part of U.S. patent application Ser. No. 10/908,137, entitled “Automatic Window Fastener and Locking System”, filed on Apr. 28, 2005.

### FIELD

The present invention relates generally to the field of window locks and fasteners. More specifically, the present invention pertains to semi-automatic and automatic window tilt latch mechanisms and systems.

### BACKGROUND

Window fasteners are commonly used for retaining and locking windows at a particular location within a window frame. In a single or double-hung type window configuration, for example, such window fasteners can be installed within a window frame and/or window sash casing and actuated to prevent or limit sliding movement of one or more windowpanes within a window frame. In a swinger or casement-type window configuration, such window fasteners can be installed within a window frame and/or window sash casing and actuated to prevent or limit swinging movement of one or more windowpanes relative to a window frame.

In a typical window installation, the window fastener may include a locking mechanism that can be actuated between an unlocked position and a locked position within the window frame. Typically, such devices include a main housing having a clasp that can be engaged manually between the unlocked and locked positions, or automatically by sliding or swinging force of the housing relative to a keeper mechanism. The clasp can be mounted either internally or externally of the housing, and can be controlled by action of a lever, handle, push button, or other suitable operator.

The complexity associated with operating many conventional window fasteners remains a significant hurdle in the art. To increase the level of intuitiveness in operating such devices, more recent designs have incorporated a sash retention mechanism that assists in automatically locking the window fastener when the window is fully closed by the user. In certain designs, for example, the latching mechanism may include a rotatable cam mechanically coupled to a number of springs that can be used to automatically lock the window fastener as it is brought into contact with the keeper mechanism to lock the window.

Despite such improvements, the ability to determine whether the window fastener is in the unlocked or locked position can be problematic for some users, particularly in those instances where the user is located far away from the mechanism. In those designs employing push buttons or levers, for example, the status of the device (e.g. pushed-in, pushed-out, left-right, up-down, etc.) may be difficult for the user to visually discern, and may not be intuitive for certain individuals such as young children or the elderly. The difficulty in visually confirming the status of the window fastener may be particularly acute in those instances where the operator is obscured at least in part within the housing, or where it is relatively small in comparison to the remaining components of the assembly. In some cases, the inability to easily view the status of the device may present a security problem since the window can appear to be fully closed and locked when it is still in the unlocked position.

The size and aesthetics of the housing, clasp and operator may also play an important consideration in the type of window fastener employed. In certain types of window fasteners for use with double-hung windows, for example, it may be desirable to sub-mount the window fastener towards the bottom portion of the window frame to reduce the load applied to the fastener as well increase the viewing area of the window for aesthetic purposes. Such size and aesthetic considerations may also be dictated by manufacturer and/or user preferences, which may vary depending on the architectural style or silhouette of the window. The window fastener will thus typically be interchangeable to accommodate different aesthetic aspects such as color, texture, style, etc.

In addition to user-intuitiveness and aesthetic considerations, the window fastener must also be configured to resist lock picking by a skilled intruder. The level of security afforded by many window fasteners typically depends on whether the latching mechanism is a shear-type design or a combined shear and torque-type design. A shear-type design is typically configured to resist loads applied to the window in only a single direction, and is thus capable of resisting only shearing forces applied to clasp within the gap separating the housing and the keeper mechanism. A shear and torque type-design, on the other hand, has the ability to withstand both shear forces and torque applied to clasp. While such locks may provide an increased level of security, they are not impervious to manipulation by a wire pick, screwdriver, knife, or other such instrument.

In some designs, an additional gap guard or interlock may be installed adjacent the clasp and keeper mechanism to prevent interference with the latching mechanism. While such devices may provide an additional level of security to the clasp, they often require the window fastener be top mounted, thus detracting from the overall aesthetics and functionality of the window fastener. Moreover, once an intruder is able to breach the gap guard or interlock, there is typically no resistance to the intruder unlatching the clasp. As a result, such mechanisms are often susceptible to picking by intruders having knowledge of the lock design.

For windows requiring additional functionality, a tilt latch mechanism can be provided in certain designs to permit the window to be tilted away, and in some cases, removed from the window frame for cleaning or other such purpose. In a double-hung or slider-type window, for example, a pair of tilt latches may sometimes be provided to permit the user to secure the window sash at a particular location relative to the window frame, thus allowing the user to gain access to the other side of the window pane for cleaning.

Conventional tilt latch mechanisms are often provided as two independent top-mounted tilt latch units, two independent sub-flush tilt latch units, or as an internal tilt latch unit. The top-mounted tilt latch units typically include a right hand unit and a left hand unit mounted to the window's upper sash. The sub-flush tilt latch units similarly include right and left-handed tilt latch units, but are typically mounted to the window's lower sash. In certain designs, the latch units may include a spring-mounted latch bolt disposed within a pair of covers and/or a housing, an actuator mechanism such as a pushbutton, and a number of mounting screws. Since two independent tilt latch units are provided, the use must typically use both hands to hold the spring-loaded lever while at the same time pulling the window sash away from the window frame. A similar procedure must then be performed to reinstall the window panel back into the window frame.

### SUMMARY

The present invention relates to automatic window tilt latch mechanisms and window fasteners. An illustrative window fastener for use with a window having a window sash and a window frame may include a housing body coupled to the window sash, a lever coupled to the housing body and actuatable between a first (i.e. unlocked) lever position and a second (i.e. locked) lever position, an actuator mechanism operatively coupled to the lever and actuatable between an unlocked position and a locked position, and a keeper mechanism coupled to the window frame. The lever can be configured to rotate and tilt outwardly away from an outer portion of the housing body in the first lever position, allowing the user to visually confirm whether the window fastener is in a locked or unlocked state. An outer portion of the housing body can include a recessed section conforming generally to the size and shape of the lever, allowing the lever to lie substantially flush or level with the outer portion of the housing body.

The actuator assembly can be configured to resist picking by an intruder, and can be activated automatically by camming motion of a component against the keeper mechanism. In certain embodiments, the actuator assembly may include a lever gear, a main latch, a hook latch, a slider mechanism, and a trigger mechanism. The main latch may include a number of notches or grooves adapted to receive a camming tab of the hook latch, allowing the main latch to be actuated between a first (i.e. locked) position and a second (i.e. unlocked) position within the housing body. The main latch and hook latch can be activated via the slider mechanism, which can be configured to move back and forth within the housing body by rotation of the lever and lever gear. The trigger mechanism can include a trigger body having a trigger finger that can be rotated into a trigger lock grove on the hook latch, securing the main latch firmly in place within the housing body. A trigger tab configured to fit with a cam slot on the keeper mechanism can be provided to automatically reset the trigger mechanism during operation.

An illustrative window locking system in accordance with an exemplary embodiment of the present invention may include a master window fastener and one or more slave window fasteners operatively coupled to the master window fastener. A linking mechanism may be provided in some embodiments to link the master window fastener to each slave window fastener, if desired. During operation, rotation of the lever on the master window fastener causes each connected slave window fastener to activate simultaneously within the window, allowing the user to lock and unlock the window using only a single lever.

An illustrative tilt latch mechanism in accordance with an exemplary embodiment of the present invention may include a central operator having a tilt latch actuator assembly, at least one tilt latch assembly actuatable between a locked position and an unlocked position, and a rod operatively connecting the tilt latch actuator assembly to the at least one tilt latch assembly. The tilt latch actuator assembly can include a tilt latch lever that can be rotated by the user to engage an idler gear connected to the rod. During use, rotational motion from the tilt latch lever is transferred to the rod via the idler gear, causing a drive shaft within each tilt latch assembly to rotate a drive pinion, engage a hook latch and then retract a latch bolt. A plunger can be used, if desired, to automatically reset the tilt latch mechanism, freeing up the operator's hands as needed to guide and delicately place the window back into the frame.

In some embodiments, the central operator may further include a window fastener actuator assembly that can be used to lock the window sash to the window frame. In other embodiments, the central operator may comprise a stand-alone model without window fastener components. A combined window fastener and tilt latch system in accordance with an exemplary embodiment of the present invention may include a central operator coupled to a window sash and including tilt latch actuator assembly and a window fastener actuator assembly, a keeper mechanism coupled to a window frame, at least one tilt latch assembly coupled to the window sash, and a means for connecting the tilt latch actuator assembly to each of the tilt latch assemblies. In some embodiments, the central operator can be connected to one or more other window fasteners to permit the window to be secured at multiple locations, if desired.

### BRIEF DESCRIPTION OF THE DRAWINGS

FIG. 1 is a perspective view of a window fastener in accordance with an illustrative embodiment of the present invention;

FIG. 2A is a perspective view showing the outer portion of the housing body of FIG. 1;

FIG. 2B is a perspective view showing the interior portion of the housing body of FIG. 1;

FIG. 3 is a cross-sectional view showing the housing body along line 3-3 in FIG. 2B;

FIG. 4A is a perspective view showing the lever of FIG. 1;

FIG. 4B is another perspective view showing the lever of FIG. 1;

FIG. 5 is a cross-sectional view showing the lever along line 5-5 in FIG. 4B;

FIG. 6 is a perspective view showing the interior components of the housing body in greater detail;

FIG. 7A is a perspective view showing the slider mechanism of FIG. 6;

FIG. 7B is another perspective view showing the slider mechanism of FIG. 6;

FIG. 8 is a perspective view showing the lever gear of FIG. 6;

FIG. 9A is a perspective view showing the main latch of FIG. 6;

FIG. 9B is another perspective view showing the main latch of FIG. 6;

FIG. 10A is a perspective view showing the hook latch of FIG. 6;

FIG. 10B is another perspective view showing the hook latch of FIG. 6;

FIG. 11A is a perspective view showing the trigger mechanism of FIG. 6;

FIG. 11B is another perspective view showing the trigger mechanism of FIG. 6;

FIG. 12A is a perspective view showing the keeper mechanism of FIG. 1;

FIG. 12B is another perspective view showing the keeper mechanism of FIG. 1;

FIG. 13A is a perspective view showing the trigger tab in a first position within the keeper mechanism of FIG. 1;

FIG. 13B is a perspective view showing the trigger tab in a second position within the keeper mechanism of FIG. 1;

FIG. 13C is a perspective view showing the trigger tab in a third position within the keeper mechanism of FIG. 1;

FIG. 13D is a perspective view showing the trigger tab in a fourth position within the keeper mechanism of FIG. 1;

FIG. 14A is a perspective view showing an alternative keeper mechanism in accordance with another illustrative embodiment of the present invention;

FIG. 14B is another perspective view showing the keeper mechanism of FIG. 14A;

FIG. 15 is a perspective view showing an illustrative bottom plate for use in securing the housing body of FIG. 1 together;

FIG. 16 is a perspective view showing a housing, lever, and lever gear subassembly;

FIG. 17 is a perspective view showing the illustrative window fastener of FIG. 1 in an unlocked position;

FIG. 18 is a perspective view showing the illustrative window fastener of FIG. 1 in a locked position;

FIG. 19 is a perspective view showing the illustrative window fastener of FIG. 1 with the trigger mechanism activated;

FIG. 20 is a perspective view showing an illustrative window fastener system in accordance with an illustrative embodiment of the present invention;

FIG. 21 is another perspective view of the illustrative window fastener system of FIG. 20 showing the attachment of the keeper body to the window frame;

FIG. 22 is another perspective view of the illustrative window fastener system of FIG. 20 showing the attachment of the housing body to the window sash casing;

FIG. 23 is another perspective view of the illustrative window fastener system of FIG. 20 showing the window fastener in an unlocked position;

FIG. 24 is another perspective view of the illustrative window fastener system of FIG. 20 showing the tilted orientation of the lever in the unlocked position;

FIG. 25 is a perspective view showing an illustrative window fastener system in accordance with an illustrative embodiment of the present invention employing multiple window fasteners;

FIG. 26 is a partial perspective view of the illustrative window fastener system of FIG. 25 showing the interior of the window sash removed to expose the connecting rod;

FIG. 27 is another perspective view of the illustrative window fastener system of FIG. 25 showing master and slave window fasteners in a locked position;

FIG. 28 is another perspective view of the illustrative window fastener system of FIG. 25 showing the master and slave window fasteners in an unlocked position;

FIG. 29 is a perspective view of an automatic window tilt latch mechanism in accordance with an illustrative embodiment of the present invention having a central operator;

FIG. 30 is a perspective view showing the central operator of FIG. 29;

FIG. 31 is an assembly view showing the interior components of the central operator of FIG. 29;

FIG. 32 is a perspective view showing the left-handed tilt latch assembly of FIG. 29;

FIG. 33 is a perspective view showing the left-handed tilt latch assembly of FIG. 29 in a second, unlocked position;

FIG. 34 is a perspective view showing the right-handed tilt latch assembly of FIG. 29;

FIG. 35 is an assembly view showing the interior components of the left-handed tilt latch assembly of FIG. 29;

FIG. 36 is a perspective view showing the illustrative window tilt latch mechanism of FIG. 29 connected to the window frame and window sash casing;

FIG. 37 is a partial perspective view of the illustrative window tilt latch mechanism of FIG. 29 showing the window sash casing removed to expose the connecting rod and tilt latch assemblies;

FIG. 38 is another perspective view showing the illustrative window tilt latch mechanism of FIG. 29 in an unlocked position;

FIG. 39 is a perspective view showing window tilt latch mechanism of FIG. 29 in an unlocked position and the window panel being tilted away from the window frame using both hands;

FIG. 40 is an assembly view showing an automatic window tilt latch mechanism in accordance with an illustrative embodiment of the present invention having a dual tilt latch configuration;

FIG. 41 is a perspective view showing the illustrative window tilt latch mechanism of FIG. 40 connected to a window frame and window sash casing;

FIG. 42 is a partial perspective view of the illustrative window tilt latch mechanism of FIG. 40 showing the window sash casing removed to expose the connecting rod and tilt latch assemblies;

FIG. 43 is a perspective view of an automatic window tilt latch mechanism in accordance with an illustrative embodiment of the present invention having a master-slave configuration; and

FIG. 44 is a partial perspective view of the illustrative window tilt latch mechanism of FIG. 43 showing the window sash casing removed to expose the connecting rod and a linking mechanism.

### DETAILED DESCRIPTION

The following description should be read with reference to the drawings, in which like elements in different drawings are numbered in like fashion. The drawings, which are not necessarily to scale, depict selected embodiments and are not intended to limit the scope of the invention. Although examples of construction, dimensions, and materials are illustrated for the various elements, those skilled in the art will recognize that many of the examples provided have suitable alternatives that may be utilized. While the various embodiments illustrated herein are described with respect to vertical and horizontally sliding windows, it should be understood that the window fastener and window tilt latch mechanism could be configured for use in rotating casement type windows as well as various door (e.g. sliding glass doors) and gate configurations.

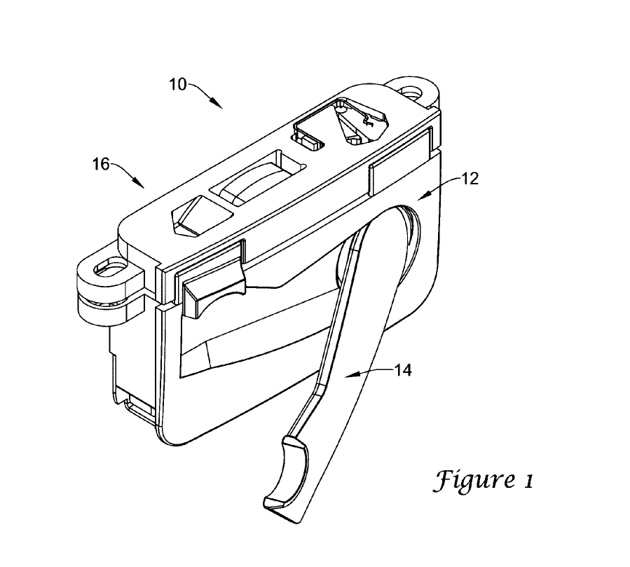

FIG. 1 is a perspective view of a window fastener 10 in accordance with an illustrative embodiment of the present invention. Window fastener 10, illustratively a sub-mount window fastener, may include a housing 12, a lever 14, and a keeper mechanism 16, which together form an assembly that can installed within a window sash and window frame of a window. In certain embodiments, for example, the window fastener 10 can be configured for sub mount installation within the lower window sash of a double-hung window. It should be understood, however, that the window fastener 10 could be configured for mounting in other locations (e.g. top mount, side mount, etc.) and/or for different types of windows (e.g. single-hung, slider, casement, etc.), as desired.

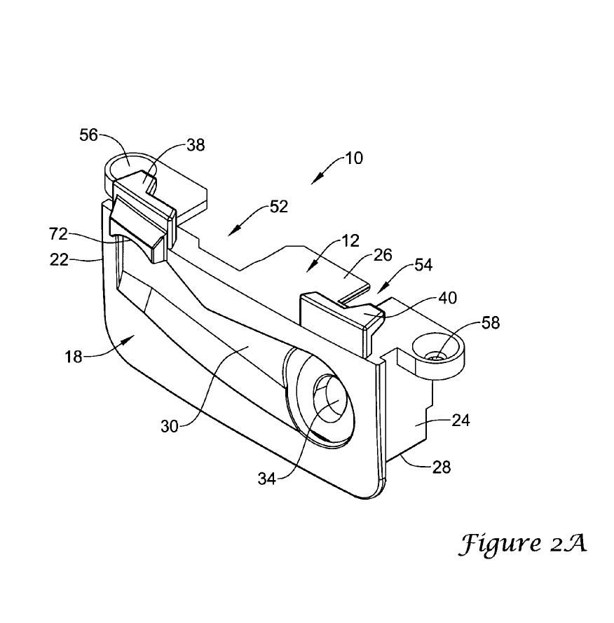

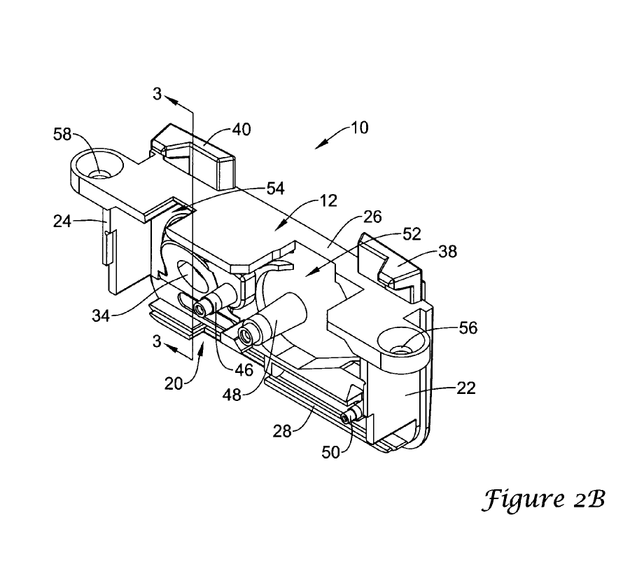

Referring now to FIGS. 2A-2B, the configuration of the housing body 12 of FIG. 1 will now be described in greater detail. As can be seen in FIGS. 2A-2B, the housing body 12 may include an outer portion 18, an inner portion 20, a first end 22, a second end 24, a first side 26, and a second side 28. The housing body 12 may comprise the main assembly enclosure of the window fastener 10, including a number of mounting posts, openings, and surfaces thereon that mechanically couple the lever 14 and keeper mechanism 16 to an internal actuator assembly, as described in greater detail below.

The housing body 12 can be formed from a material or combination of materials having sufficient strength to withstand repeated actuation of the window fastener 10 during normal operation, and that resists any forces applied to the device by an intruder using a wire pick, screwdriver, knife blade, or other such instrument. The selection of materials may depend on the desired strength of the housing body 12, the size and shape of the housing body 12, as well as manufacturing considerations such as ease of fabrication and/or assembly. In certain embodiments, for example, the housing body 12 may be formed from or otherwise include a metal such as zinc, which can be easily manufactured while having a sufficient strength to resist warping during repeated use. It should be understood, however, that other types of metals and/or polymeric materials could be utilized to form the housing body 12, if desired.

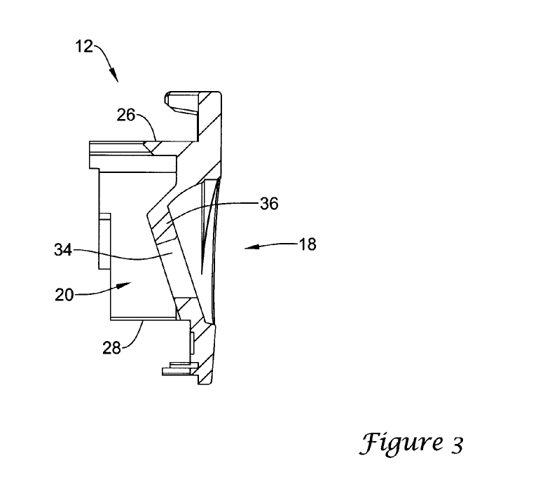

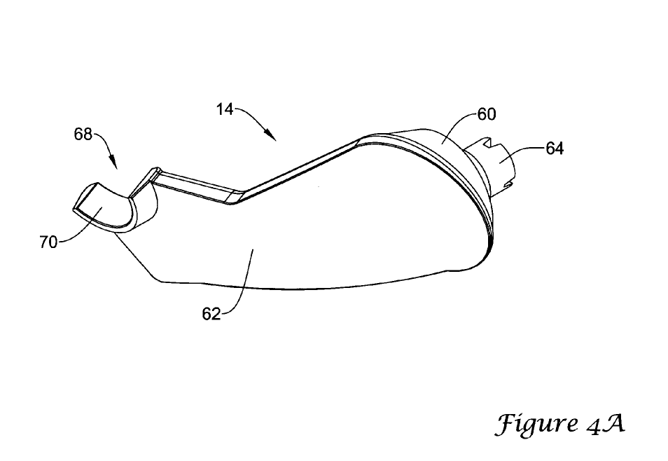

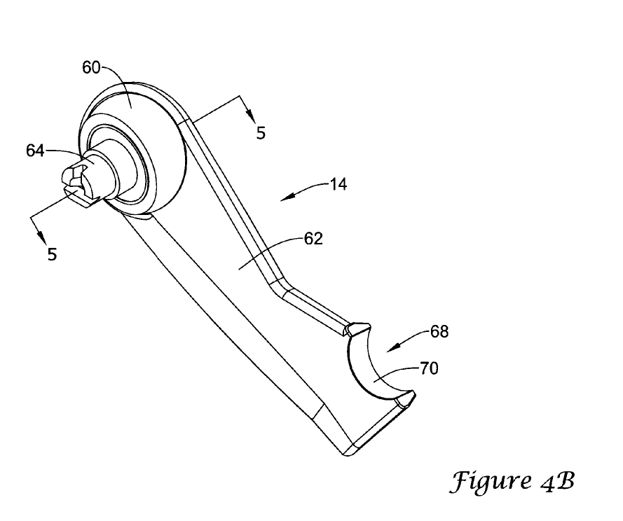

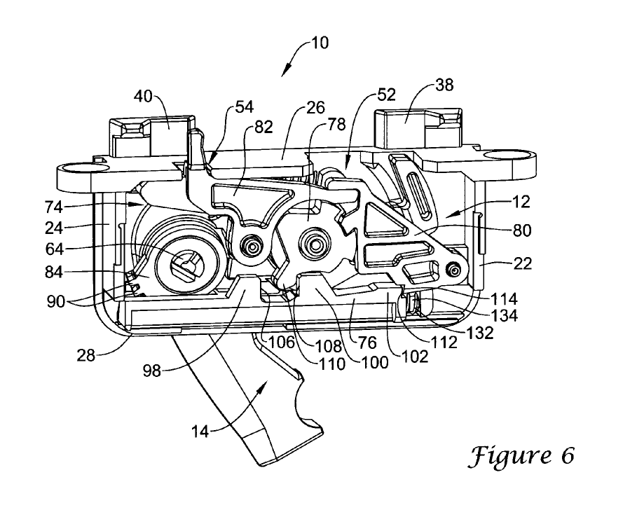

The outer portion 18 of the housing body 12 can include a recessed section 30 conforming generally to the size and shape of the lever 14, allowing the lever 14 to lie substantially flush or level with the outer portion 18 of the housing body 12 when the window fastener 10 is rotatably engaged into a locked position. A main opening 34 disposed through the housing body 12 can be configured to rotatably receive a lever post 64 (see FIGS. 4A-4B) that mechanically connects the lever 14 to the actuator assembly located within the interior portion 20 of the housing body 12. As can be seen in cross-section in FIG. 3, the main opening 34 may be defined by a flanged portion 36 of the housing body 12 that is offset slightly at an angle relative to the outer portion 18 thereof. In use, the offset orientation of the main opening 34 acts to impart a slight tilt to the lever 14 during rotation, providing an enhanced degree of visualization to the user that the lever 14 is in an unlocked position. Such offset in orientation further acts to orient a lever gear 84 (see FIG. 6) at a slight angle within the interior portion 20 of the housing body 12.

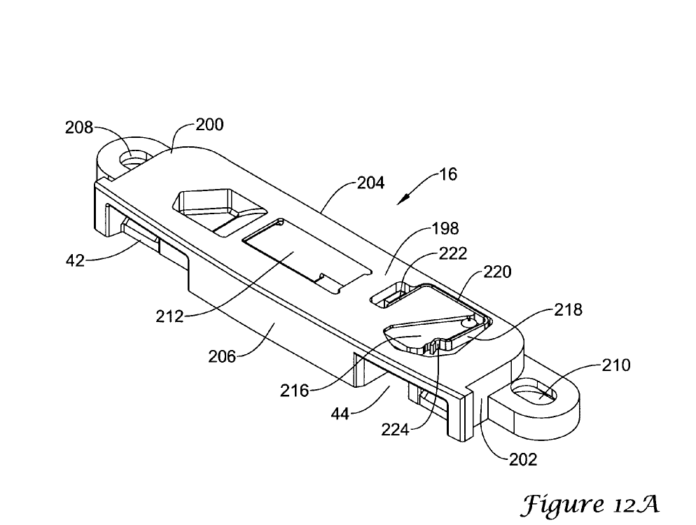

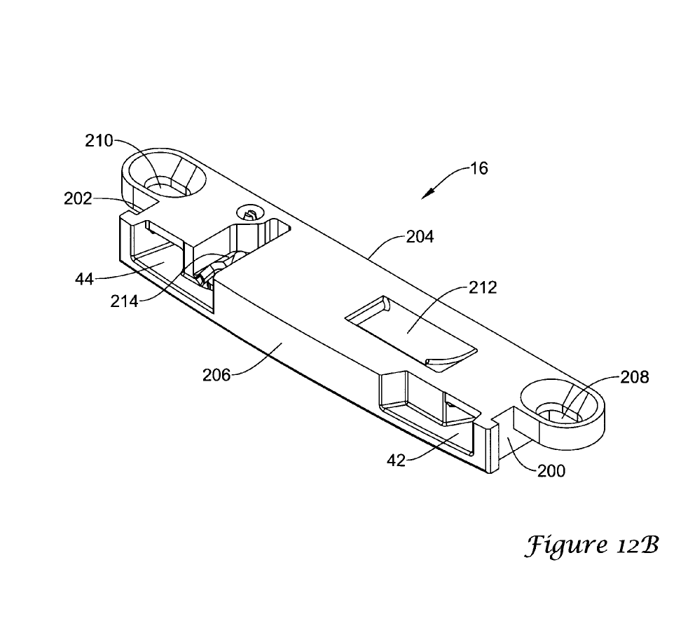

The first side 26 of the housing 12 may include a number of interlocking guide tabs 38,40 that can be configured to lock within a corresponding set of groves 42,44 (see FIGS. 12A-12B) formed in the keeper mechanism 16, thereby ensuring proper alignment of the housing body 12 with the keeper mechanism 16. In some applications, the guide tabs 38,40 may further act to limit access of an intruder's wire pick, screwdriver tip, or knife blade within the narrow gap disposed between the housing body 12 and keeper mechanism 16, further preventing interference with the internal actuator assembly while also obviating the need for a separate gap guard or interlock.

As can be further seen in FIG. 2B, the interior portion 20 of the housing body 12 may include a number of mounting posts 46,48,50 for connection of the various components of the internal actuator assembly. In certain embodiments, the mounting posts 46,48,50 may each include drafts, which aid in casing of the various parts to be inserted thereon, and which bias the moving parts to pivot and/or move in a desired direction during operation. Other features such as support grooves and steps can be further imparted to the housing body 12 to limit and/or control the operation of the various components of the actuator assembly, as desired. In some cases, such support grooves and/or steps can be further configured to facilitate assembly of the components in a top-down fashion within the housing body 12, reducing assembly time and manufacturing variability.

A first opening 52 disposed through the first side 26 of the housing body 12 exposes a portion of the housing interior to permit ingress and egress of a clasp used to secure the housing body 12 to the keeper mechanism 16. A second opening 54 disposed through the first side 26 of the housing body 12, in turn, exposes a portion of the housing interior to receive a trigger tab that can be used to automatically trigger and lock the window fastener 10 when the housing body 12 is brought into contact with the keeper mechanism 16. A set of mounting holes 56,58 located adjacent the first and second ends 22,24 of the housing body 12 can be further provided for mounting the housing body 12 to a window sash or window frame.

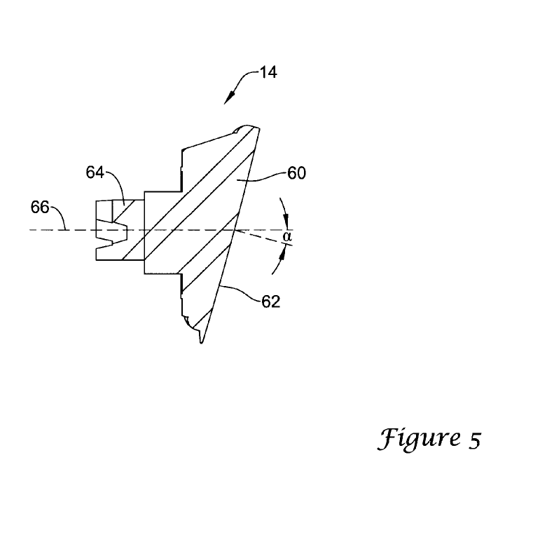

FIGS. 4A-4B are front and back perspective views showing the illustrative lever 14 of FIG. 1 in greater detail. As shown in FIGS. 4A-4B, the lever 14 may include a base section 60 and an arm section 62. The base section 60 of the lever 14 may include a lever post 64 adapted to fit within opening 34 of the housing body 12. As can be further seen in cross-section in FIG. 5, the centerline 66 of the lever post 64 can be oriented at an angle α relative to the arm section 62, which in conjunction with the flange portion 36 of the housing body 12, causes the arm section 62 to tilt or swing outwardly away from the housing body 12 as the lever 14 is rotated to its unlocked position. In certain embodiments, for example, the lever post 64 can be offset of an angle α of between about 10° to about 25°, and more specifically about 15° to about 20°, although other angles greater or lesser than these ranges are possible. The arm section 64 of the lever 14 can be dimensioned to lie flat or flush within the recessed section 30 of the housing body 12 when in a fully locked position. In some embodiments, the arm section 64 can be contoured to match the general contour or curvature of the outer portion 18 of the housing body 12.

In use, the ability of the lever 14 to tilt outwardly away from the housing body 12 while rotated provides the user with a visual indicator that the window fastener 10 is in an unlocked position. Such visualization may be further enhanced by the size and shape of the lever 14, which may extend along a majority of the length of the housing body 12. The size and tilting feature of the lever 14 can be configured to enhance visualization of the lever 14 at relatively large distances (e.g. from a position across a room) and from different vantage points, allowing the user to confirm whether the window fastener 10 is locked without having to approach the device.

A cupped section 68 of the arm section 62 located opposite the base section 60 can be provided to facilitate rotation of the lever 14 by the user. In certain embodiments, for example, the cupped section 68 may comprise a semi-circular notch 70 configured to align with a corresponding semi-circular notch 72 (see FIG. 2A) on the housing body 12 when the lever 14 is engaged in the fully locked position. In use, the circular opening formed by the notches 70,72 allows the user to insert a finger to initiate rotation of the lever 14 from the locked position to the unlocked position. Once the user has initiated rotation of the lever 14 vis-à-vis the notches 70,72, the tilted configuration of the lever 14 allows the user to then grip the lever arm 62 with their hand to continue rotation to the unlocked position. In use, the size and shape of the cupped section 68, in addition to the rotation and tilt features described above, act to resist any unauthorized manipulation by way of a wire pick, screwdriver tip, knife blade, or other such instrument.

The lever 14 may have either a right-handed configuration or a left-handed configuration, depending on the application. Thus, while a right-handed configuration is specifically show in the illustrative embodiment of FIG. 1, it should be understood that an opposite (i.e. left-handed) arrangement could be provided. The configuration of the lever 14 may be dictated by the installation location of the window fastener 10, aesthetic considerations, or a combination of both. The configuration of the lever 14 may also vary in those applications where multiple window fasteners are employed. If, for example, a window utilizes two window fasteners located on opposite sides of a window frame edge, then one of the fasteners may have a right-handed configuration whereas the other window fastener may have a left-handed configuration. Other configurations are possible, however.

FIG. 6 is a perspective view showing the interior components of the housing body 12 in greater detail. As shown in FIG. 6, the housing body 12 may include an actuator assembly 74 that can be actuated via the lever 14 between an unlocked position and a locked position. In the illustrative embodiment of FIG. 6, the actuator assembly 74 may include a slider mechanism 76, a main latch 78, a hook latch 80, and a trigger mechanism 82. A lever gear 84 operatively coupled to the lever post 64 can be configured to linearly translate the slider mechanism 76 back and forth within the housing body 12 to operate the main latch 78 and hook latch 80 between an unlocked position and a locked position when the lever 14 is rotated by the user.

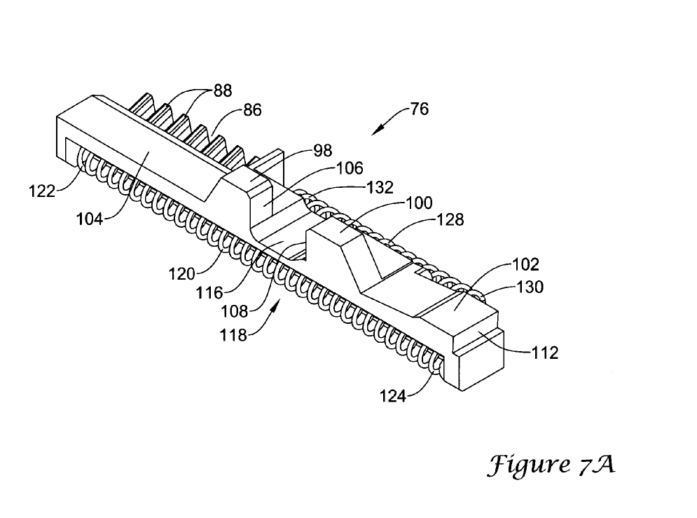

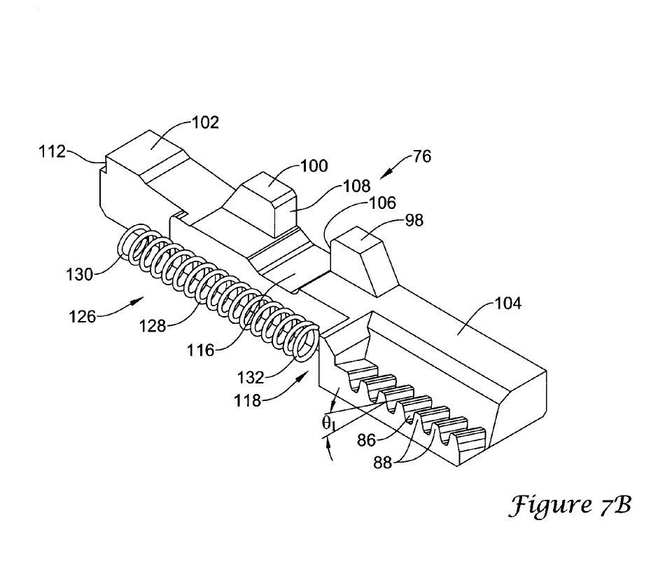

As can be further understood by reference to FIGS. 7A-7B, the slider mechanism 76 may include a rack 86 having a number of gear teeth 88 adapted to mate with and engage a corresponding set of gear teeth 90 formed on the lever gear 84. The gear teeth 88 on the rack 86 may be offset at an angle relative to the gear teeth 90 on the lever gear 84 to compensate for the offset angle at which the lever 14 is connected to the housing body 12. In certain embodiments, for example, the gear teeth 88 on the rack 86 may include a number of mitered gear teeth that are offset at an angle θ₁ of between about 10° and 30°, and more specifically, about 15° to 25°, although other configurations are possible. In use, the offset angle θ of the gear teeth 88 on the rack 86 acts to provide more flexibility to the movement of the other components of the actuator assembly 74 (e.g. the main latch 78, the hook latch 80, the trigger mechanism 82, etc.) while also reducing the overall space within the housing body 12.

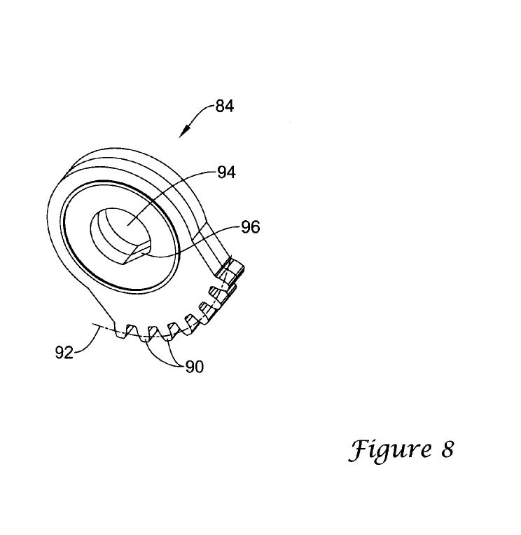

To further reduce interference with the other components of the actuator assembly 74, and in order to reduce the overall size of the housing body 12, the gear teeth 90 of the lever gear 84 may extend about only a portion of the perimeter of the gear 84. In one such embodiment depicted in FIG. 8, for example, the lever gear 84 may comprise a sector gear having a number of gear teeth 90 disposed about an imaginary arc 92 of about 60° to 80°, and more specifically about 65° to 75°, although other ranges greater or lesser than these values are possible. The lever gear 84 may further define an opening 94 adapted to slidably receive the lever post 64. A flat 96 formed within the opening 94 of the lever gear 84 can be used to impart rotational movement of the lever post 64 to the lever gear 84 when the lever 14 is rotated. Other configurations such as a hex, square star, etc. may also be utilized to impart rotational movement of the lever post 64 to the lever gear 84, if desired.

The slider mechanism 76 may include a number of camming tabs 98,100,102 that function to rotatably engage the main latch 78 and hook latch 80 in response to linear translation of the slider mechanism 76 back and forth within the housing body 12. As can be seen in FIGS. 6 and 7A-7B, for example, a first and second camming tab 98,100 may extend upwardly from a top portion 104 of the slider mechanism 76, forming an opposing set of camming surfaces 106,108 adapted to engage a cam guide 110 of the main latch 78. A third camming tab 102 extending upwardly from the top portion 104 of the slider mechanism 76, in turn, can be configured to form a third camming surface 112 adapted to engage a notch 114 formed on the hook latch 80.

During operation, rotational movement of the lever 14 and lever gear 84 causes the slider mechanism 76 to translate in position linearly within the housing body 12, which at certain pre-determined positions causes the camming tabs 98,100,102 to engage the cam guide 110 and notch 114 and induce rotation of the main latch 78 and hook latch 80. A small recess or indention 116 within the top portion 104 of the slider mechanism 76 may provide additional clearance for cam guide 110 as the slider mechanism 76 translates the position of the main latch 78.

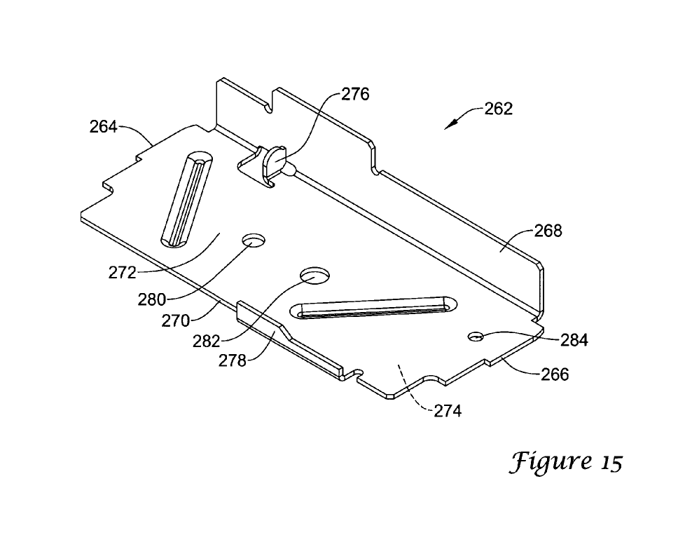

A first slot or groove 118 disposed within a first side of the slider mechanism 76 can be configured to provide clearance for a first compression spring 120 having a first end 122 and a second end 124, as shown in FIG. 7A. The first end 122 of the first compression spring 120 can be configured to rest against and is axially constrained by a tab 276 located on the bottom plate 262 (see FIG. 15) used to secure the housing body 12 together. The second end 124, in turn, can be configured to rest against and is axially constrained by a portion of the slider mechanism 76. In use, the first compression spring 120 can be configured to bias the slider mechanism 76 towards a contracted position (i.e. to the left in FIG. 6), which can be overcome by rotating the lever 14 from the unlocked position to the locked position.

A second slot or groove 126 disposed within a second side of the slider mechanism 76 can be configured to provide clearance for a second compression spring 128 having a first end 130 and a second end 132, as shown in FIG. 7B. The second compression spring 128 can be coupled to the hook latch 80 and to the housing body 12, and can be configured to bias the hook latch 80 in a locked position against the main latch 78. The second compression spring 128 may be shorter in length than the first compression spring 120, and unlike the first compression spring 120, does not act to spring bias the spring mechanism 128.

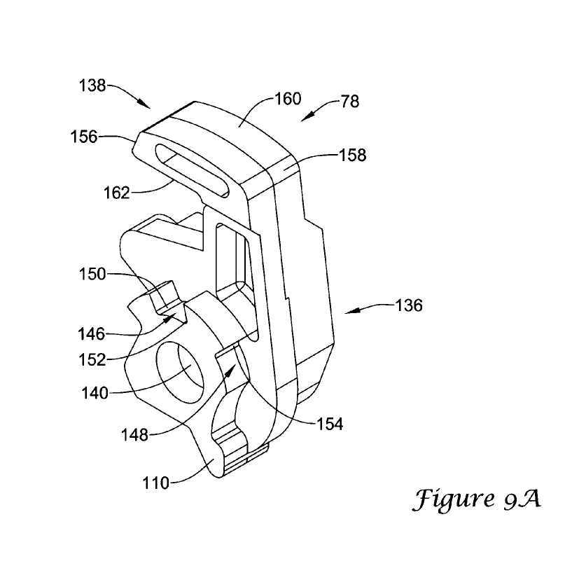

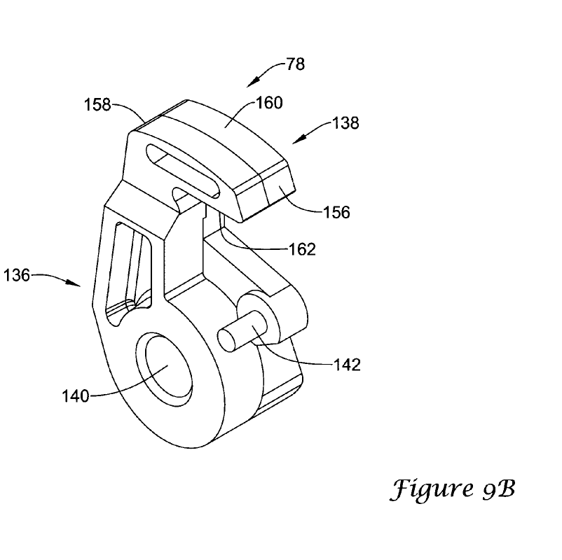

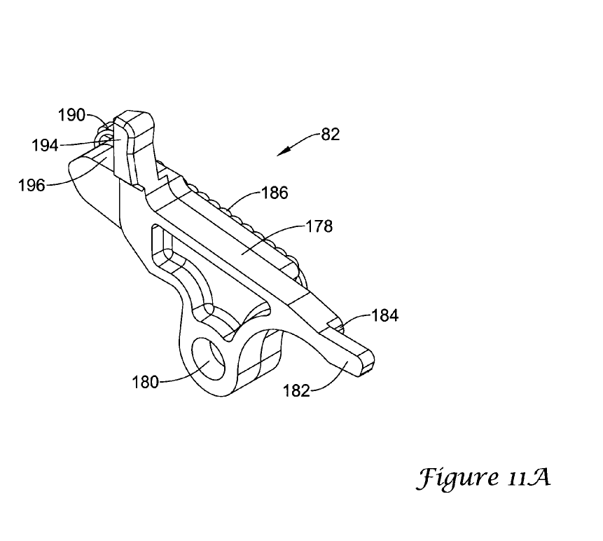

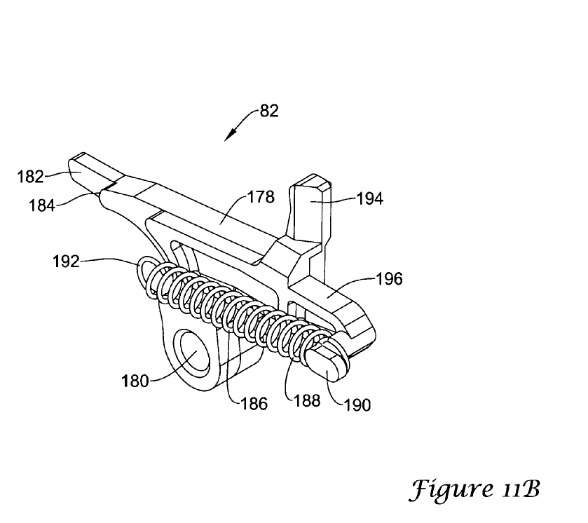

FIGS. 9A-9B are perspective views showing the main latch 78 of FIG. 6 in greater detail. As shown in FIGS. 9A-9B, the main latch 78 may include a body section 136 and a clasp section 138. An opening 140 disposed through the body section 136 of the main latch 78 can be configured to rotatably fit about mounting post 48 located within the interior portion 20 of the housing body 12, fixing the positioning of the main latch 78 while permitting rotational motion therein. As shown in FIG. 9B, a post 142 extending from one side of the body section 136 can be configured to receive the end of a tension spring 186 coupled to the trigger mechanism 82 (see FIG. 11B), which applies a tension or pulling force on the main latch 78 that counteracts the compression or pushing force imparted to the main latch 78 via the second compression spring 128 and hook latch 80.

The body section 136 of the main latch 78 may further define a number of camming notches or grooves that can be configured to mate with a corresponding camming tab 144 formed on the hook latch 80, allowing the main latch 78 to be engaged between two discrete positions corresponding to the unlocked and locked positions. As shown in FIG. 9A, for example, a first notch 146 formed at a first location of the body section 136 can be configured to mate with the camming tab 144 when the main latch 78 is rotatably engaged in a fully unlocked position. A second notch 148 formed at a second location of the body section 136, in turn, can be configured to mate with the camming tab 144 when the main latch 78 is rotatably engaged in a fully locked position.

In certain embodiments, each of the first and second notches 146,148 can be dimensioned to permit over-center vectoring of the camming tab 144 therein. In such configuration, the mounting posts 48,50 are aligned such that the resulting vector when the camming tab 144 engages each notch 146,148 tends to swing the camming tab 144 and notch 146,148 towards each other, thereby creating a locking wedge to prevent picking by an intruder and/or to prevent unlatching of the device once locked. If desired, a number of small grooves 150,152,154 inset within the base of each notch 146,148 can be provided in some embodiments to facilitate the over-center vectoring of the camming tab 144 therein.

The clasp section 138 of the main latch 78 may comprise a hook-type clasp having a leading end 156, a trailing end 158, a first surface 160, and a second surface 162. The first surface 160 and the ends 156,158 of the clasp section 138 can be rounded and/or tapered slightly to facilitate the smooth engagement of the clasp section 138 within the keeper mechanism 16 during operation. The second surface 162 of the clasp section 138, in turn, may have a substantially flat configuration to facilitate frictional engagement of the clasp section 138 against the contact surfaces of the keeper mechanism 16.

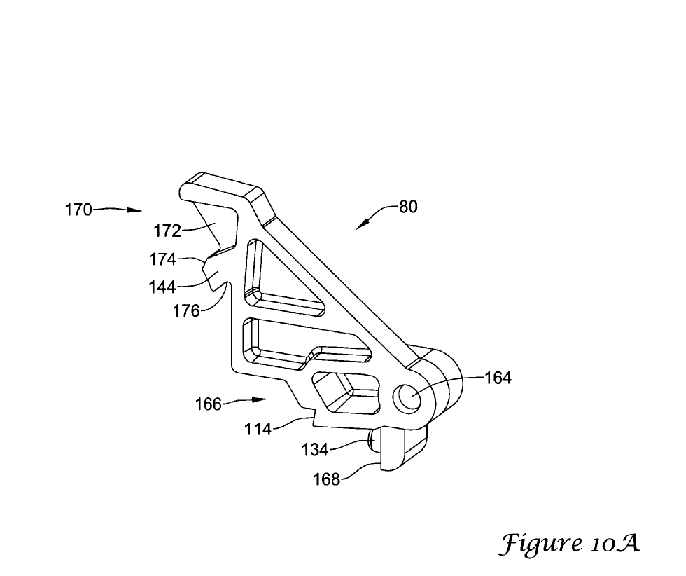

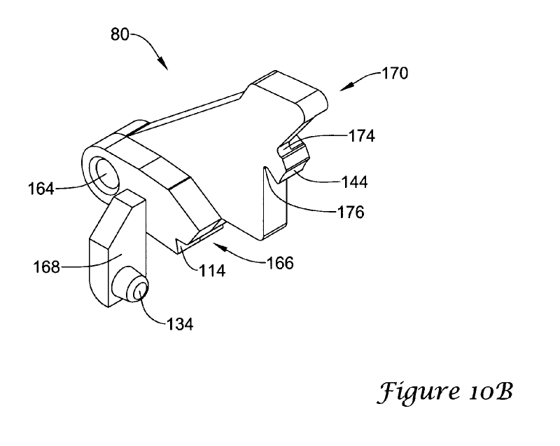

FIGS. 10A-10B are perspective views showing the hook latch 80 of FIG. 6 in greater detail. As shown in FIGS. 10A-10B, the hook latch 80 may be rotatably secured to the housing body 12 via an interior opening 164 configured to rotatably fit about mounting post 50 located within the interior portion 20 of the housing body 12. A lower section 166 of the hook latch 68 may include the boss 134 used to couple the hook latch 80 to the second compression spring 128. A flanged portion 168 of hook latch 80 can be configured to translate the biasing force of the second compression spring 128 to the lower section 66 of the hook latch 80. An upper section 170 of the hook latch 80 may include the camming tab 144 and a trigger lock groove 172 coupling the hook latch 80 to the trigger mechanism 82. The camming tab 144 can include a number of notches or grooves 174,176 disposed at or near the base of the camming tab 144 that facilitate over-center vectoring of the camming tab 144 within the notches 146,148 on the main latch 78.

FIGS. 11A-11B are perspective views showing the trigger mechanism 82 of FIG. 6 in greater detail. As shown in FIGS. 11A-11B, the trigger mechanism 82 may include a trigger body 178 defining an opening 180 configured to rotatably fit about mount post 46 located within the interior portion 20 of the housing body 12, fixing the positioning of the trigger mechanism 82 while permitting rotational motion therein. A trigger finger 182 extending outwardly from the trigger body 178 can be configured to engage the trigger lock groove 172 formed in the upper section 170 of the hook latch 80. The trigger lock groove 172 can be made slightly larger than the trigger finger 180 to permit the trigger finger 182 to move up and down within the trigger lock groove 172 while maintaining constant contact therewith as the hook latch 80 engages the main latch 78 between the unlocked and locked positions. If desired, a rounded portion 184 of the trigger body 178 located adjacent to the base of the trigger finger 182 can be provided as a guide for the trigger finger 182 as it is engaged within the trigger lock groove 172. Internally, the trigger mechanism 82 is considered downstream activation from the hook latch 80 such that the trigger finger 182 can activate the hook latch 80, but, conversely, the hook latch 80 cannot activate the trigger mechanism 82.

In the illustrative embodiment depicted, rotational motion of the trigger body 178 is further constrained using a tension spring 186 coupled at a first end 188 to a spring catch 190 disposed on the trigger body 178, and at a second end 192 thereof to post 142 disposed on the body section 136 of the main latch 78. In use, the tension spring 186 applies tension loading to the main latch 78, which acts to bias the main latch 78 in the reset position (i.e. in a counter-clockwise direction in FIG. 6). The tension spring 186 thus stores potential energy that, in conjunction with the second compression spring 128, acts to automatically lock the window fastener 10 during operation. The tension spring 184 also acts to lead the force applied to the hook latch 80 in tandem with the second compression spring 128 to prevent lockup during actuation.

A trigger tab 194 extending upwardly from the trigger body 178 can be configured to actuate the trigger mechanism 82 between an unlocked and a locked position, depending on the direction of the housing body 12 relative to the keeper mechanism 16. The trigger tab 194 is dimensioned to fit within an opening on the keeper mechanism 16, and can be configured to automatically activate when the housing body 12 is engaged against the keeper mechanism 16 in a particular direction. During operation, a portion 196 of the trigger body 178 located opposite the trigger finger 182 can be configured to engage the first side 26 of the housing body 12, further locking the positioning of the main latch 78.

FIGS. 12A-12B are perspective views showing the keeper mechanism 16 of FIG. 1 in greater detail. As shown in FIGS. 12A-12B, the keeper mechanism 16 may include a keeper body 198 having a first end 200, a second end 202, a first side 204, and a second side 206. A set of mounting holes 208,210 located adjacent the first and second ends 200,202 of the keeper body 198 can be utilized for mounting the keeper body 198 to a stationary member such as a window frame or window sash using a number of mounting screws, if desired.

A main opening 212 disposed through the keeper body 198 can be dimensioned to receive the clasp section 138 of the main latch 78 therein. A cam slot 214 disposed through the keeper body 198, in turn, can be configured to receive at least a portion of the trigger tab 194 extending upwardly from the trigger mechanism 82, coupling the triggering mechanism 82 to the keeper mechanism 16. In certain embodiments, and as shown in FIG. 12A, the cam slot 214 can be configured to receive a pivot latch 216 that acts as a one-way activator for the trigger tab 194, allowing the trigger mechanism 82 to activate only upon either manual depression of the trigger tab 194 by the user, or automatically by movement of the housing body 12 against the keeper body 198 when the window fastener 10 is engaged in its fully locked position.

The pivot latch 216 can include a post (hidden) that permits the pivot latch 216 to rotate within the cam slot 214 to restrict movement of the trigger tab 194 therein. A leaf spring 218 disposed within a spring slot 220 formed on the keeper body 198 can be configured to restrict rotational movement of the pivot latch 216 in only a single direction within the cam slot 214. The leaf spring 218 may have a first end 222 fixedly secured within the spring slot 220, and a second end 224 thereof operatively coupled to the pivot latch 216.

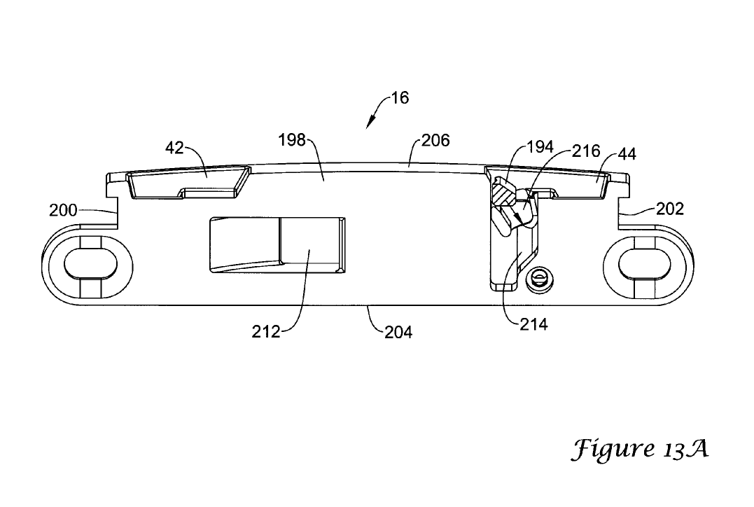

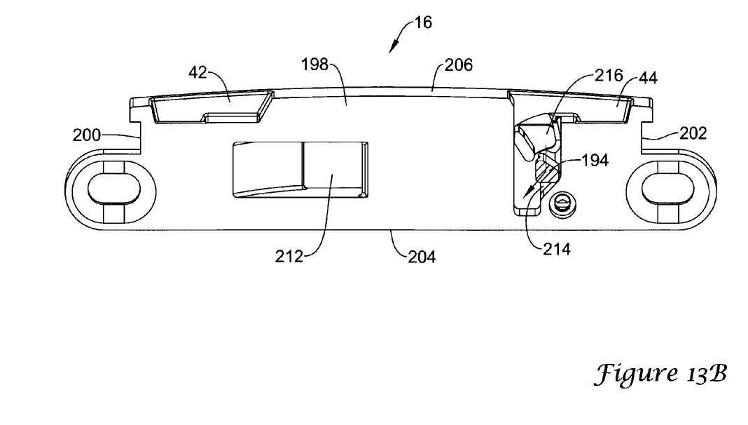

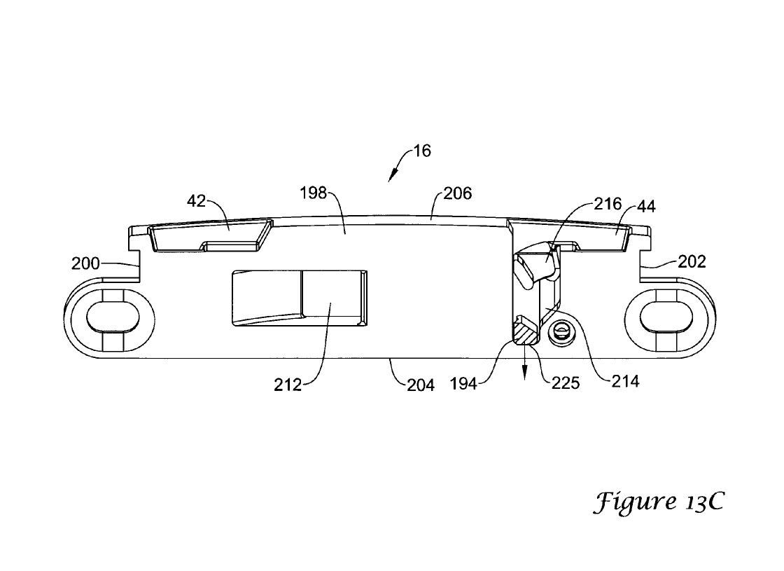

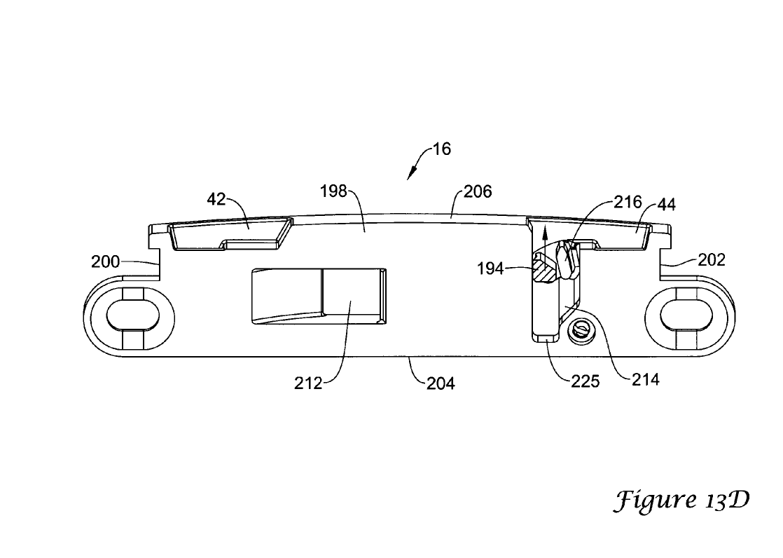

FIGS. 13A-13D are perspective views showing movement of the trigger tab 194 within the keeper mechanism 16 during operation. As shown in a first (i.e. inactivated) position in FIG. 13A, as the trigger tab 194 enters the keeper mechanism 16 in the direction indicated generally by arrow, it passes the pivot latch 216 without interruption. As shown in a second position in FIG. 13B, for example, the trigger tab 194 can be configured to move through the cam slot 214 in the direction of the arrow without engaging the pivot latch 216, allowing the trigger mechanism 82 to activate within the keeper mechanism 16. Once the window is fully closed, and as shown in a third (i.e. fully activated) position in FIG. 13C, the trigger tab 194 can be configured to lock within section 225 of the cam slot 214, causing the main latch 78 and trigger mechanism 82 to lock. In this position, the trigger mechanism 82 can be configured to prevent the main latch 78 from being unlocked, allowing protection from an intruder using a wire pick, screwdriver tip, knife blade, or other such instrument forced into the gap between the housing body 12 and keeper body 198. When the window is subsequently moved back to an open position, and as shown in a fourth position in FIG. 13D, the trigger tab 194 is adapted to travel back through the cam slot 214 and contact the pivot latch 216, causing the pivot latch 216 to return to a spring-loaded position. At this time, the trigger tab 194 will normally be traveling out of the cam slot 214 with the pivot latch 216 rotating freely so that the trigger mechanism 82 does not activate.

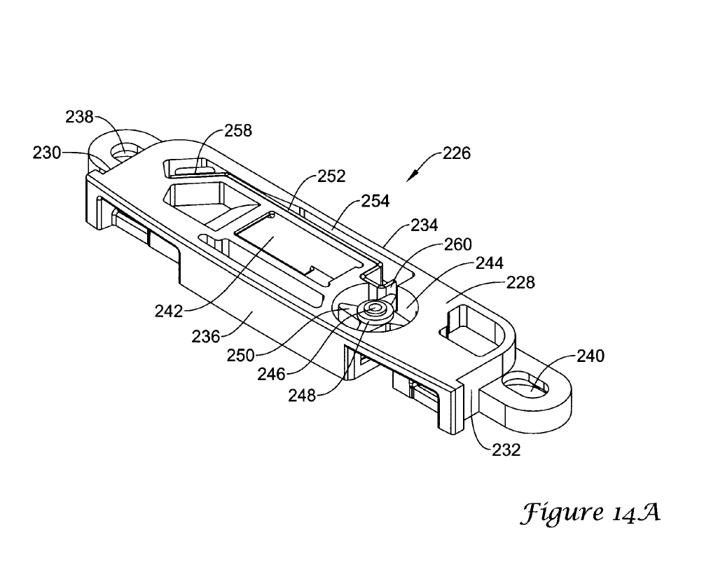

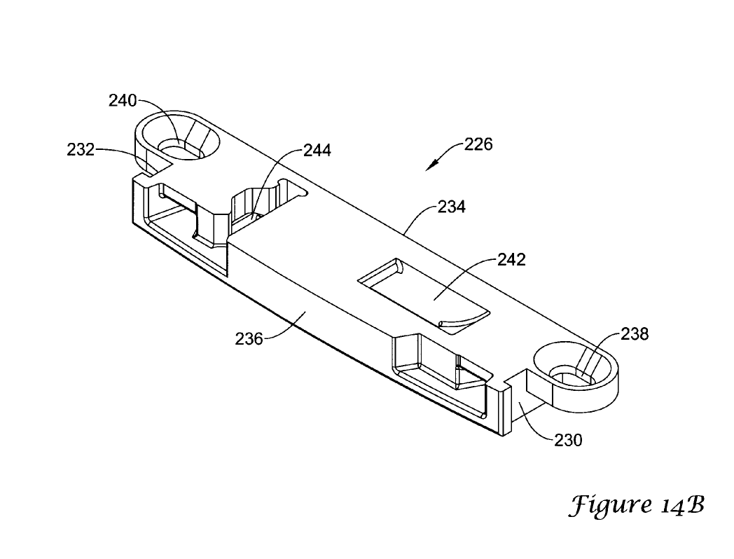

FIGS. 14A-14B are perspective views showing an alternative keeper mechanism 226 in accordance with another illustrative embodiment of the present invention. As shown in FIGS. 14-14B, the keeper mechanism 226 may include a keeper body 228 having a first end 230, a second end 232, a first side 234, and a second side 236. A set of mounting holes 238,240 located adjacent the first and second ends 230,232 of the keeper body 226 can be utilized for mounting the keeper body 228 to a stationary member such as a window frame or window sash using a number of mounting screws, if desired.

A main opening 242 disposed through the keeper body 228 can be dimensioned to receive the clasp section 138 of the main latch 78, similar to the embodiment of FIGS. 12A-12B. A cam slot 244 disposed through the keeper body 228, in turn, can be configured to receive at least a portion of the trigger tab 194 extending upwardly from the trigger mechanism 82. In the illustrative embodiment of FIGS. 14A-14B, a mounting post 246 disposed within the cam slot 244 can be configured to receive a star-shaped activator 248 that acts as a one-way activator for the trigger tab 194, allowing the trigger mechanism 82 to activate only upon either manual depression of the trigger tab 194 by the user, or automatically by movement of the housing body 12 against the keeper body 228 when the window fastener 10 is engaged in its fully locked position.

The star-shaped activator 248 may include a number of outwardly extending arms 250 configured to permit rotational movement of the activator 248 in only a single direction within the cam slot 244. In the illustrative embodiment depicted in FIGS. 14A-14B, for example, the start-shaped activator 248 may include four equally spaced arms 250 that function by restricting movement of the trigger tab 194. A leaf spring 252 disposed within a spring slot 254 formed on keeper body 228 can be configured to restrict rotational movement of the star-shaped activator 248 in only a single direction within the cam slot 244. The leaf spring 252 may have a first end 258 fixedly secured within the spring slot 254, and a second end 260 that extends at least a portion into the cam slot 244 for contact with the arms 250 of the star-shaped activator 248. The second end 260 of the leaf spring 252 may have a substantially U-shaped configuration that permits displacement of the leaf spring 252 when the star-shaped activator 248 is rotated in a first direction (e.g. clockwise), but is substantially prevented from rotational movement in the opposite direction (e.g. counter-clockwise). The arms 250 can be dimensioned with various angles, bevels, and flats so as to facilitate rotational movement of the star-shaped activator 250 within the cam slot 244.

In use, each time the star-shaped activator 248 is tripped and rotation occurs, the arms 250 can be configured to pass over the second end 260 of the leaf spring 252 while being substantially prevented from rotating backwards by the spring action of the leaf spring 252. As the star-shaped activator 248 is rotated within the cam slot 244, the trigger tab 194 is allowed to extend through the cam slot 244 and activate, automatically resetting the triggering mechanism 82 in the unlocked position. The star-shaped activator 248 is thus forced to index over just prior to the housing body 12 and keeper body 228 coming to their final alignment when the window is fully closed. The cam slot 244 can be configured in length such that the trigger tab 194 will trip the trigger mechanism 82 and then reset back into a start position by the time the housing body 12 fully aligns with the keeper body 228. If necessary, the trigger mechanism 82 can be manually activated by depressing the trigger tab 194 downwardly within the cam slot 244.

FIG. 15 is a perspective view showing an illustrative bottom plate 262 for use in securing the housing 12 together. As shown in FIG. 15, the bottom plate 262 may have a first end 264, a second end 266, a first side 268, and second side 270. The first and second ends 268,270 of the bottom plate 262 can be configured to align, respectively, with the second and first ends 24,22 of the housing body 12. The first and second sides 268,270 of the bottom plate 262, in turn, can be configured to align, respectively, with the second and first sides 28,26 of the housing body 12. In certain embodiments, the bottom plate 262 can be fabricated from a thin piece of sheet metal having a sufficient strength to withstand picking action by an intruder. A stiffening rib or other stiffening member (not shown) can be provided on the bottom plate 262 to ensure that the sheet metal remains flat within the window sash casing, if necessary.

When attached to the housing body 12, an interior side 272 of the bottom plate 262 can be configured to face inwardly within the interior portion 20 of the housing body 12, securing the various components of the actuator assembly 74 therein. An exterior side 274 of the bottom plate 262, in turn, can be configured to lie flush within a cutout of the window sash. A first bent tab 276 extending outwardly from the interior side 272 of the bottom plate 262 can be configured to act as a back stop for the first compression spring 120 used to spring bias the slider mechanism 76, as described above with respect to FIG. 7A. A second bent tab 278 disposed along at least a portion of the second side 270 can also be provided in certain embodiments to restrict access to the interior housing space adjacent the main latch 78 by a wire pick, screwdriver tip, knife blade, or other such instrument. A number of thru-holes 280,282,284 formed at various locations within the bottom plate 262 can be provided to match the pattern of the mounting posts 46,48,50 on the housing body 12. These thru-holes 280,282,284 can be utilized during assembly to firmly secure the various components of the actuator assembly 74 together within the interior portion 20 of the housing body 12.

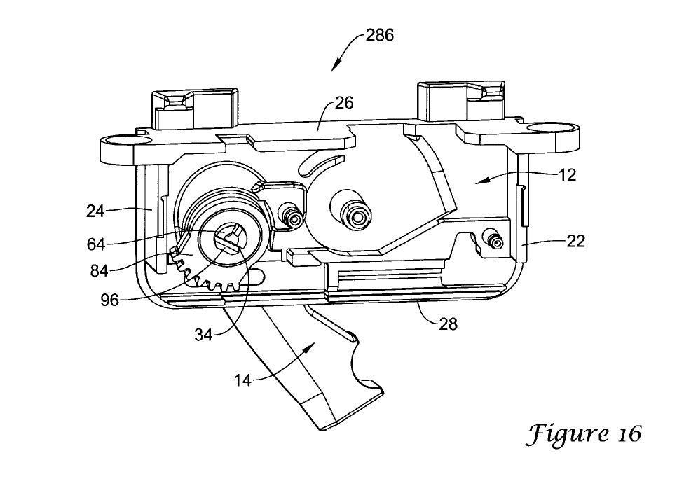

To aid in reducing assembly time and cost, the various components of the actuator assembly 74 can be configured to fit within the interior portion 20 of the housing body 12 using a top-down assembly technique, wherein each component of the actuator assembly 74 is installed individually and then subsequently trapped by the insertion of the next assembly component and/or the bottom plate 262. In one such technique, for example, the housing body 12 and lever 14 can be positioned in an assembly nest with the lever post 64 and the mounting posts 46,48,50 of the housing body 12 each facing in the same direction. In this configuration, the lever post 64 can then be inserted through opening 34 and aligned with the flat 96 disposed within the opening 94 of the lever gear 84. Once aligned, the lever gear 84 can then be inserted over the lever post 64, forming a housing, lever, and lever gear subassembly 286, as shown, for example, in FIG. 16. If desired, a temporary shaft insert (not shown) may be inserted between the lever post 64 and the opening 34 to provide a protective barrier if the manufacturer desires to paint the housing, lever, and lever gear subassembly 286 as a single subassembly.

The fabrication of the housing body 12, lever 14, and lever gear 84 as a separate subassembly 286 may provide the manufacturer with greater flexibility in customizing the color, finish, and/or labeling of the product without affecting the other components of the device. Moreover, the ability to fabricate these components as a separate subassembly 286 may further reduce the need for additional assembly equipment, thus increasing the manufacturability of the device.

Once the housing, lever, and lever gear subassembly 286 is fabricated, the installer may next insert the other components of the actuator assembly 286 one at a time into the interior portion 20 of the housing body 12, including the main latch 78, the hook latch 80, the trigger mechanism 82, the slider mechanism 76, as well as the various compression and tension springs 120,128,186. Once assembled together, the bottom plate 262 can then be attached to the housing body 12, securing all of the components of the actuator assembly 74 therein.

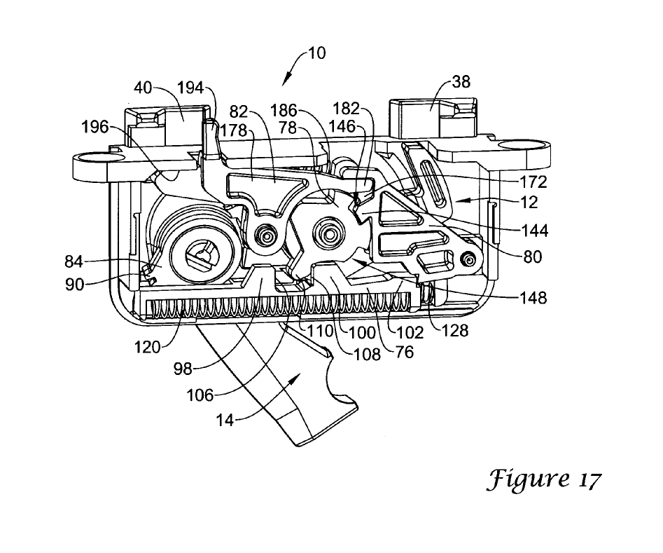

Referring now to FIGS. 17-19, an illustrative method of operating the window fastener 10 of FIG. 1 will now be described. In an initially unlocked position depicted in FIG. 17, the full rotation of the lever 14 outwardly away from the housing body 12 causes the lever gear 84 to engage the slider mechanism 76 in a fully extended position (i.e. to the left in FIG. 17). Actuation of the slider mechanism 76 in the fully extended position causes the camming surface 108 on the second camming tab 100 to engage the cam guide 110 of the main latch 78, causing the main latch 78 to rotate in a clockwise direction relative to the hook latch 80. During this time, the pressure exerted on the hook latch 80 via the second compression spring 128 is at a minimum, allowing the camming tab 144 on the hook latch 80 to displace and engage the first notch 146 on the main latch 78, as shown.

In the unlocked position, and as further shown in FIG. 17, the trigger finger 180 can be configured to displace within the trigger lock groove 172 of the hook latch 80, allowing the main latch 78 to rotate relative to the hook latch 80. In this position, the trigger tab 194 is disengaged within the cam slot 214 of the keeper body 198 as a result of the tensile spring loading force of the tension spring 186.

To activate the window fastener 10 to the locked position, the user may engage the housing body 12 against the keeper body 198, causing the tabs 38,40 to interlock with the grooves 42,44 thus securing the housing body 12 to the keeper mechanism 16. In those embodiments where the housing body 12 is sub-mounted to the window sash of a single or double-hung window, for example, the engagement of the housing body 12 against the keeper body 198 may occur by sliding the window sash downwardly until the tabs 38,40 snap into place within the grooves 42,44. If desired, the interlocking of the tabs 38,40 within the grooves 42,44 can be configured to produce a clicking noise, providing the user with feedback that the two members 12,198 are coupled together.

As the housing body 12 is engaged against the keeper body 198, a series of events occur causing the trigger mechanism 82 to activate. First, movement of the housing body 12 against the keeper body 198 causes the trigger tab 194 to travel into the cam slot 214. When this occurs, the force of the leaf spring 218 restricts the rotation of the pivot latch 216, which, in turn, forces the trigger tab 194 to cam over and then cam back within the keeper body 198. The length of the cam slot 214 can be configured such that the trigger mechanism 82 will trip and then reset back into its start position by the time the housing body 12 is fully engaged against the keeper body 198. Once the window is fully closed, the trigger mechanism 82 can be configured to not activate until subsequent rotation of the lever 14, preventing unauthorized manipulation within the gap between the housing body 12 and the keeper mechanism 16.

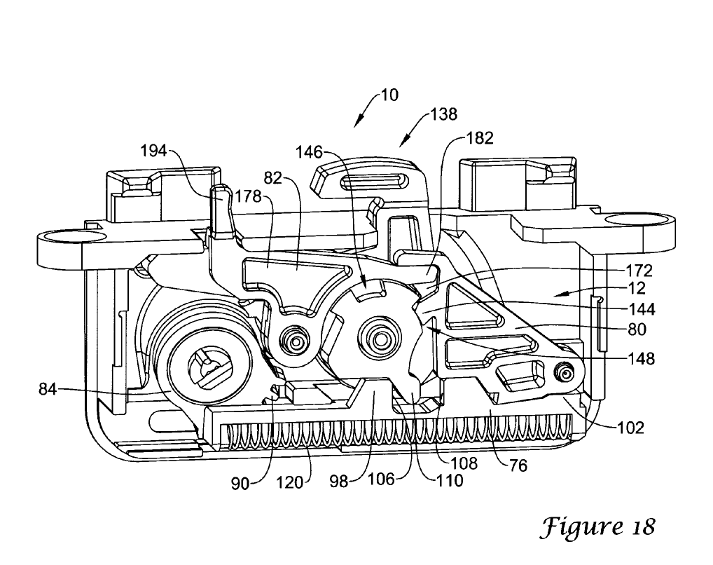

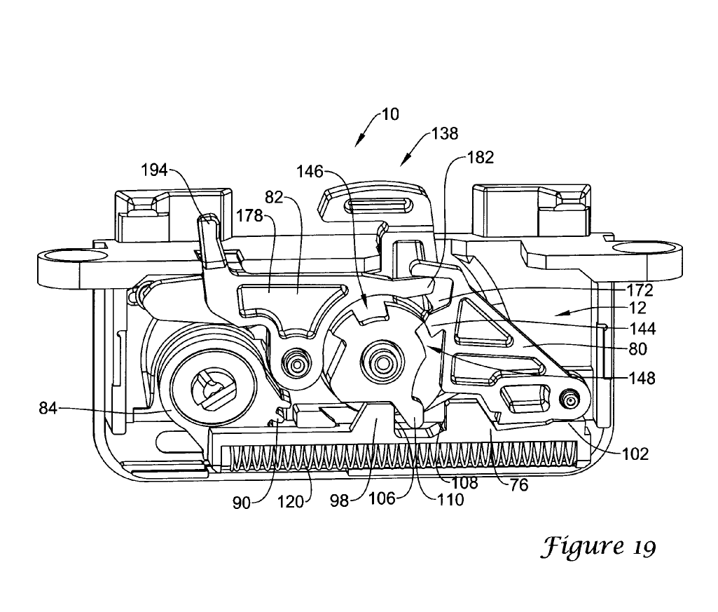

As the trigger tab 194 is cammed over, the slight rotational movement of the trigger body 178 causes the trigger finger 182 to tip the hook latch 80 a sufficient distance to permit the camming tab 144 to disengage within the first notch 146. With the camming tab 144 disengaged, and with the potential energy stored with the compression and tension springs 120,128,186 from the previous rotation of the lever 14, the main latch 78 is then allowed to rotate within the housing body 12. In this state, the lever 14 can then be rotated, causing the first camming tab 98 on the slider mechanism 76 to engage the cam guide 110 on the main latch 78. Continued rotation of the lever 14 in this direction causes the main latch 78 to rotate to a second position, causing the camming tab 144 on the hook latch 80 to lock into position within the second notch 148 of the main latch 78, as shown, for example, in a second position in FIG. 18. In this position, the clasp section 138 is disposed furthest within the opening 212 of the keeper body 198, preventing any sliding movement between the housing body 12 and mechanism 16. In a fully locked position, and as shown in a third position in FIG. 19, for example, the trigger mechanism 82 can then be activated, preventing the window fastener 10 from being unlocked.

To subsequently unlock the window fastener 10, the lever 14 can be rotated manually from its starting position inset within the housing body 12, causing a series of events within the housing body 12 that disengages the clasp section 138 from the keeper body 198. First, the rotation of the lever 14 outwardly away from the housing body 12 causes the gear teeth 90 on the lever gear 84 to engage the gear teeth 88 on the rack 86, counteracting the spring loaded force applied by the first compressive spring 120 and forcing the slider mechanism 76 to linearly translate from its default (i.e. extended) position towards a retracted position within the housing body 12. In certain embodiments, the slider mechanism 76 can be configured to provide a built in delay such that initial rotation of the lever 14 is resisted only by the compression spring loading provided by the first compression spring 120. Such built in delay feature facilitates initial rotation of the lever 14 by the user's finger since only a minimal amount of force is necessary to overcome the spring force of the first compressive spring 120.

Once the lever 14 is initially rotated, continued rotation thereof causes the first camming tab 98 on the slider mechanism 76 to engage the camming guide 110 of the main latch 78, inducing rotation of both the main latch 78 and the hook latch 80. Due to the camming action of the first camming tab 98 against the camming guide 110, the main latch 78 is rotated to its maximum retracted position, causing the tension spring 186 to stretch and store potential energy. As this occurs, the hook latch 80 disengages the third camming tab 102 on the slider mechanism 76 and displaces to permit the camming guide 144 of the hook latch 80 to re-engage the first notch 146 of the main latch 78. As this occurs, the trigger tab 194 is held firm within the cam slot 214, preventing the trigger mechanism 82 from activating as the hook latch 80 engages the main latch 78.

Once the main latch 78 is retracted within the housing body 12, the user may then open the window by sliding the housing body 12 away from the keeper body 198. When this occurs, the pivot latch 216 displaces, allowing the trigger tab 194 to pass through the cam slot 214 in the keeper body 198 instead of camming over. With the lever 14 rotated and held in the unlocked position, the window can then be moved to any desired position except a fully closed position.

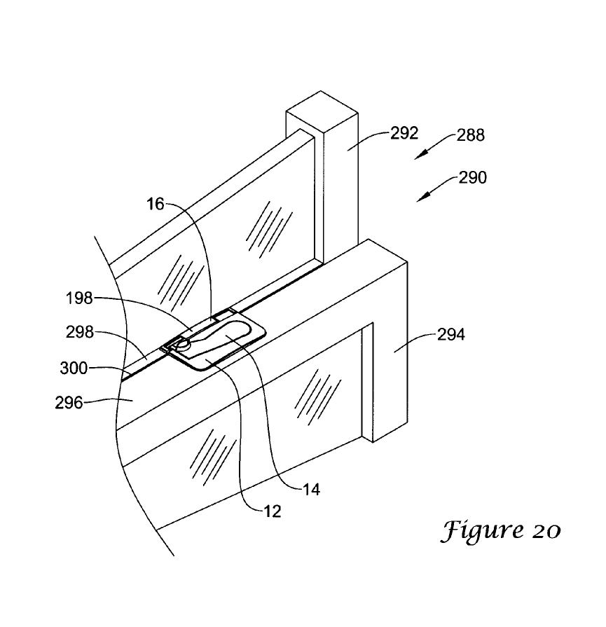

Referring now to FIGS. 20-24, an illustrative window fastener system 288 employing the illustrative window fastener 10 of FIG. 1 will now be described. As shown in a first view in FIG. 20, the window fastener system 288 may include a window 290 having a window frame 292 and a window sash 294, which can be configured to support the keeper body 198 and housing body 12, respectively. In a generally closed position depicted in FIG. 20, the lever 14 can be configured to align substantially flush with the exterior of the housing body 12, allowing the housing body 12 to assume a relatively low profile along the edge 296 of the window sash 294.

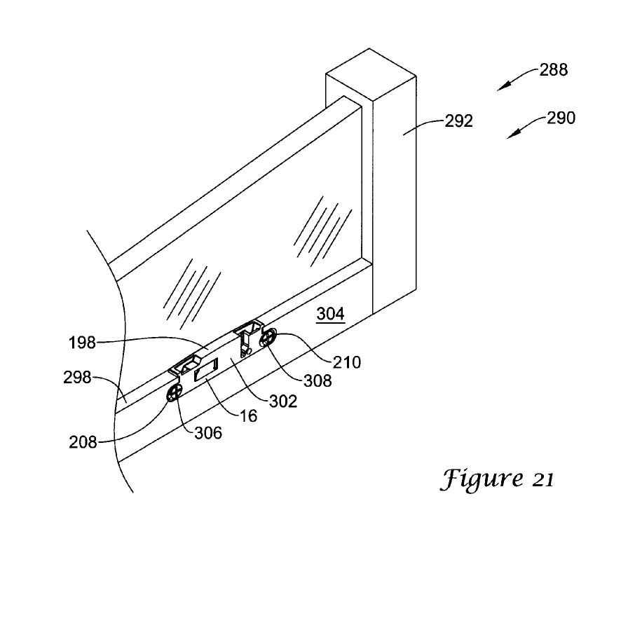

The keeper body 198 can be inset within an edge 298 of the window frame 292 to minimize the gap 300 between the keeper body 198 and the housing body 12. In certain embodiments, and as further shown in FIG. 21, for example, the keeper body 198 can be mounted such that the exposed portion 302 thereof is aligned substantially flush with the surface 304 of the edge 298. Mounting of the keeper body 198 can be accomplished using a screw, nail or other suitable fastener 306,308 inserted within the set of mounting holes 208,210, which can be countersunk within the keeper body 198 to prevent interference with the housing body 12.

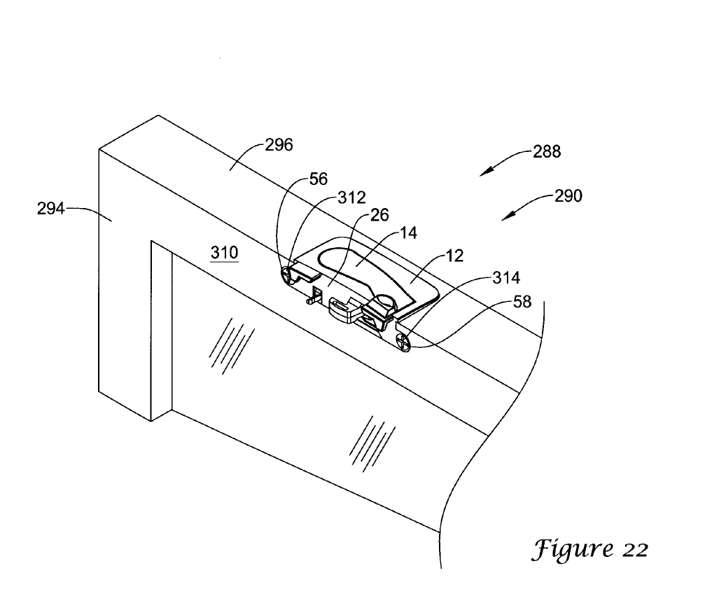

The housing body 12 can be similarly inset within edge 296 of the window sash 294. In certain embodiments, and as shown in FIG. 22, for example, the housing body 12 can be mounted such that the first side 26 thereof is aligned substantially flush with the surface 310 of the edge 296. As with the keeper body 198, the housing body 12 can be mounted to the edge 296 using a screw, nail or other suitable fastener 312,314 inserted within the set of mounting holes 56,58, which can be similarly countersunk to prevent interference with the keeper body 198.

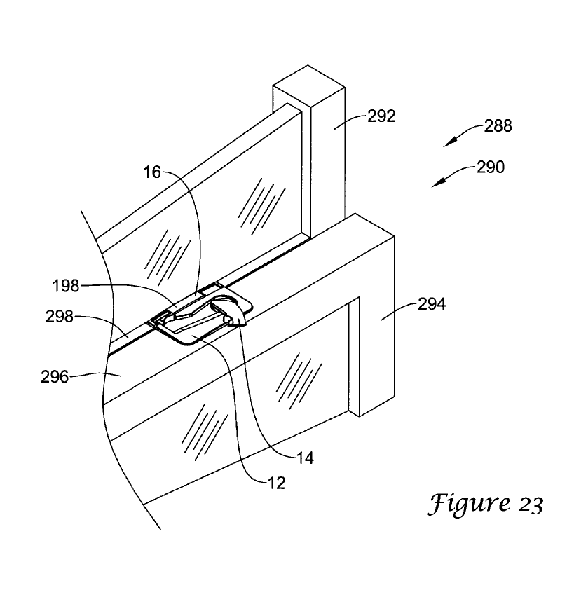

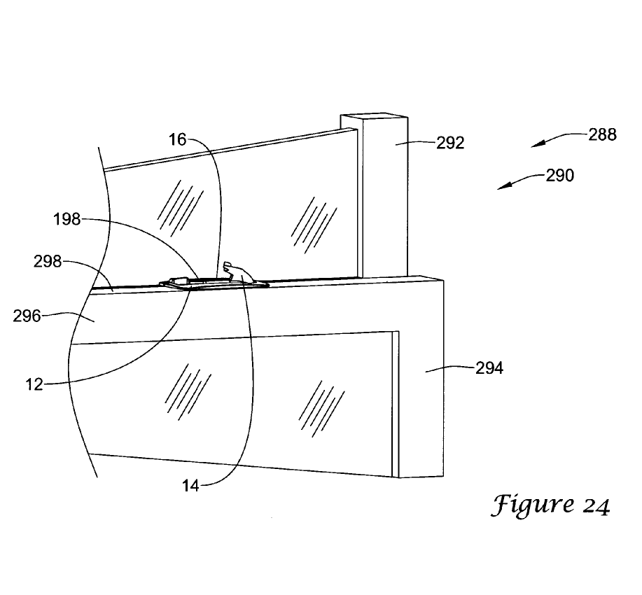

FIG. 23 is another perspective view of the illustrative window fastener system 288 of FIG. 20, wherein the window fastener 10 is shown in an unlocked position. As shown in FIG. 23, rotation of the lever 14 between the locked position and unlocked position causes the lever 14 to rotate away from the housing body 12. In addition, and as further shown in FIG. 24, rotation of the lever 14 between the locked position and unlocked position also causes the lever 14 to tilt outwardly away from the exterior of the housing body 12. The ability of the lever 14 to both rotate and tilt relative to the housing body 12 improves the ability of the user to visually confirm the status of the window fastener 10, particularly in those instances where the user is located far away from the window 290.

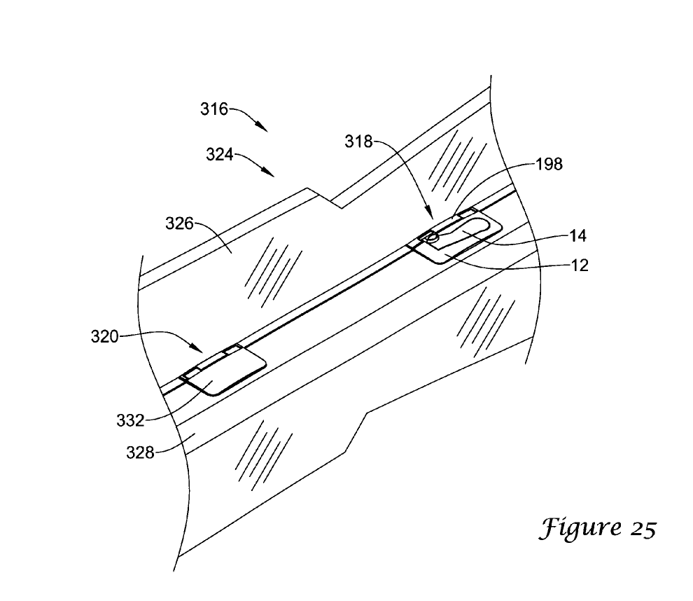

Referring now to FIGS. 25-28, an illustrative window fastener system 316 employing multiple window fasteners will now be described. As shown in a first view in FIG. 25, the window fastener system 316 may include a master window fastener 320 and one or more slave window fasteners 322, each of which can be inset within a window 324 having a window frame 326 and window sash 328. The master window fastener 320 can be configured similar to the window fastener 10 described hereinabove, with like elements labeled in like fashion in the drawings. In the illustrative embodiment depicted, however, the master window fastener 318 may be operatively coupled to an adjacent slave window fastener 320, which can be utilized to secure the window frame 326 to the window sash 328 at a second location separate from the master window fastener 318. In some applications, for example, the addition of the slave window fastener 320 can be utilized in a relatively large window where multiple locks are specified and/or where additional security may be needed. While the use of two window fasteners 318,320 is specifically depicted in FIG. 25, it should be understood that the master window fastener 318 could be coupled to one or more additional slave window fasteners, if desired. Moreover, while the lever 14 for the master window fastener 318 depicted in FIG. 25 has a right-handed configuration, it should be understood that the lever 14 may have a left-handed configuration, if desired.

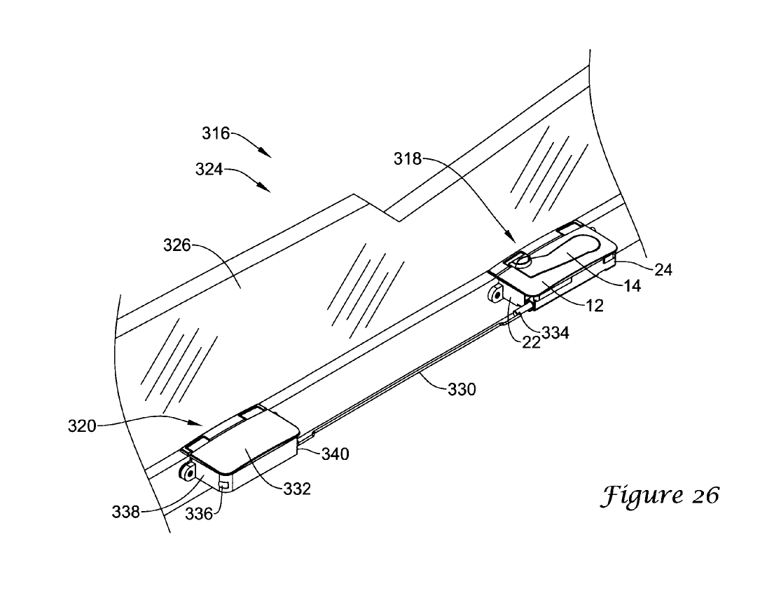

In certain embodiments, the master window fastener 318 can be operatively coupled to the slave window fastener 320 via a wire, rod, or other linking mechanism. As shown in a second view in FIG. 26, for example, a connecting rod 330 mechanically connecting the master window fastener 318 to the slave window fastener 320 can be configured to translate rotational motion applied to the lever 14 to an actuator assembly disposed within the slave window fastener 320. The connecting rod 330 may be connected at one end to the slider mechanism 76 disposed within the housing body 12 of the master window fastener 318, and at a second end thereof to a slider mechanism disposed within the housing body 332 of the slave window fastener 320. A number of openings 334 formed at each end 22,24 of the master housing body 12 allow passage of the connecting rod 330 into the master window fastener 318. A similar set of openings 336 formed at each end 338,340 of the slave housing body 332 allow passage of the connecting rod 330 into the slave window fastener 320.

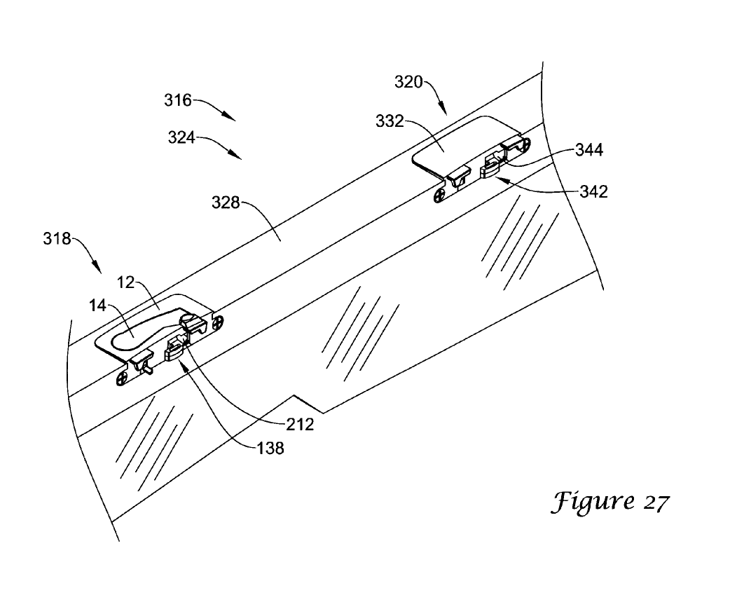

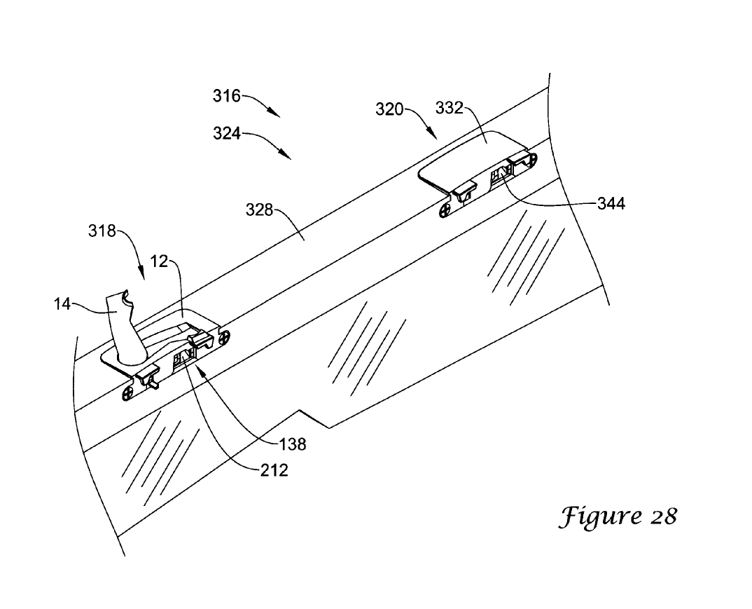

FIG. 27 is another perspective view of the illustrative window fastener system 316 of FIG. 25, wherein the master and slave window fasteners 318,320 are shown in a locked position. As can be seen in FIG. 27, rotation of the lever 14 to its fully locked position causes the clasp section 138 of the master window fastener 318 to fully extend through opening 212 of the master housing body 12. Such rotation of the lever 14 can also be configured to simultaneously engage a similar clasp section 342 of the slave window fastener 320, causing the clasp section 342 to fully extend through an opening 344 of the slave housing body 332, as shown. To subsequently unlock the window fasteners 318,320 and disengage the clasp sections 138,342, the user may rotate the lever 14 away from the housing body 12, causing both clasp sections 138,342 to simultaneously unlock, as shown, for example, in FIG. 28.

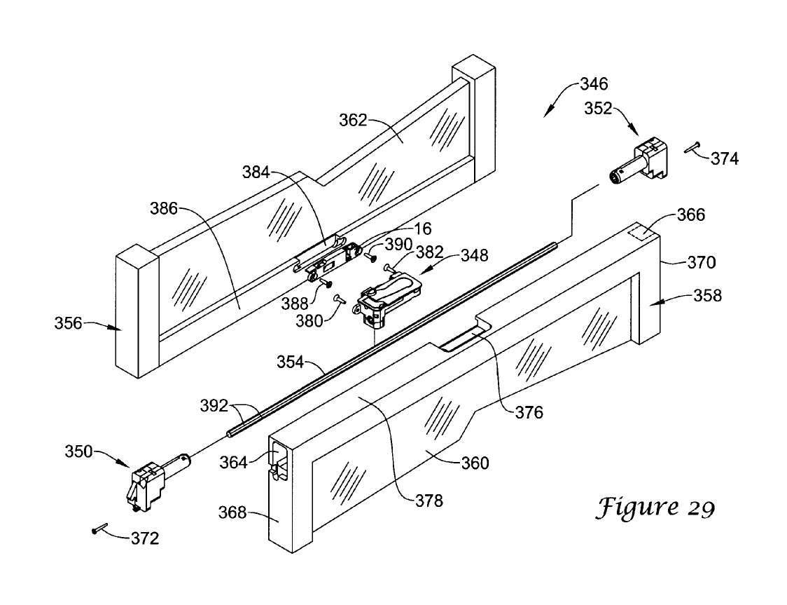

Referring now to FIG. 29, an automatic window tilt latch mechanism 346 employing a single central operator will now be described. As shown in FIG. 29, the tilt latch mechanism 346 may include a central operator 348, a left-handed tilt latch assembly 350, a right-handed tilt latch assembly 352, and a connecting rod 354 connecting the central operator 348 to the left and right-handed tilt latch assemblies 350,352. As is described in greater detail below, the window tilt latch mechanism 346 can be installed within a window having a window frame 356 and window sash casing 358 to provide a means for the user to tilt the window away and, in some cases, remove the window from the window frame. In a double-hung type window configuration illustrated in FIG. 29, for example, such mechanism 346 can be used to tilt the window panel 360 supported by the window sash casing 358 away from the window frame 356 to facilitate cleaning of the interior side of the window panel 360 or to perform some other desired maintenance.

The left and right-handed tilt latch assemblies 350,352 can be configured to fit within a corresponding cutout 364,366 formed within the sides 368,370 of the window sash casing 358. The tilt latch assemblies 350,352 can be secured to the sides 368,370 using screws 372,374 or other suitable fastener. The central operator 348, in turn, can be configured to fit within a cutout 376 formed on an edge 378 of the window sash casing 358, and can be secured thereto using screws 380,382 or other suitable fastener. In those embodiments where the central operator 348 is also adapted to function as a window fastener, as described herein, a keeper mechanism 16 can be secured within a cutout 384 formed on an edge 386 of the window frame 356 using screws 388,390 or other suitable fastener.

The connecting rod 354 can be configured to translate rotational motion from the central operator 348 to each of the tilt latch assemblies 350,352. The connecting rod 354 may have a transverse shape equipped with a number of flats 392 disposed radially about the rod 354 at equal angles, which facilitates torque transfer from the central operator 348 to the tilt latch assemblies 350,352. In the illustrative embodiment of FIG. 29, for example, the connecting rod 354 has a hexagonal configuration including six flats radially disposed at equal angles about the outer surface of the rod 354 and extending along at least a portion of the length of the rod 354. It should be understood, however, that other configurations (e.g. triangular, square, octagonal, etc.) could also be used to transfer torque from the central operator 348 to the latch assemblies 350,352, if desired.

In addition to providing a means for transferring torque to the tilt latch assemblies 350,352, the flats 392 further act to reduce the size of the through-hole passage required to insert the connecting rod 354 through the interior of the window sash casing 358 while, at the same time, increasing its strength. Such configuration may also be more intuitive to install, in some cases eliminating the need for specifying window width tolerances for proper latch actuation prevalent in many conventional designs. By utilizing a rotatable rod 354 to actuate the tilt latch assemblies 350,352, the central operator 348 need not be centrally located along the edge 378 of the window sash casing 358, but instead can be positioned at any location thereon, as desired.

The connecting rod 354 can be manufactured to match the length of the window, allowing the mechanism 346 to be installed in any number of different types of windows. The connecting rod 354 can be cut to length from a long stock piece of material based the manufacturer's specific length requirements. In certain embodiments, for example, the connecting rod 354 can be fabricated from an extruded metal such as aluminum, which is both strong and lightweight. Other suitable metals or metal composites such steel, stainless steel, nickel-plated brass, etc. can also be utilized, if desired. Depending on the length and/or strength requirements specified, polymers or metal/polymer composites can also be used to fabricate the connecting rod 354. In those embodiments in which a metal extrusion technique is used, a deburring process can be employed to remove any rough edges on the ends of the rod 354, if necessary.

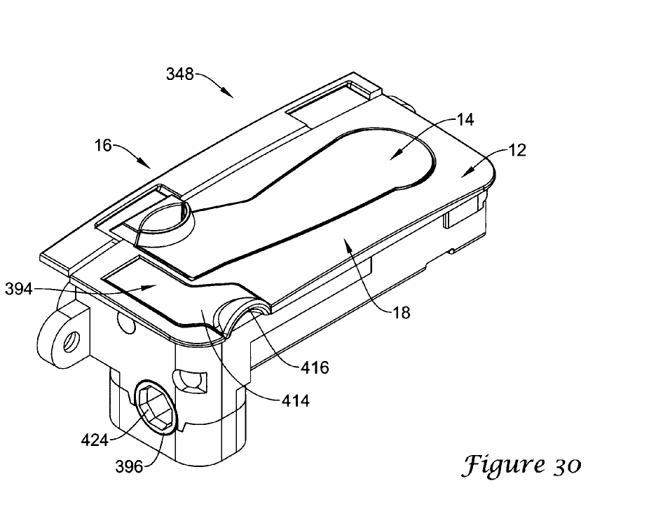

FIG. 30 is a perspective view showing the central operator 348 of FIG. 29 in greater detail. The central operator 348 may be configured in many respects similar to the window fastener 10 described hereinabove with respect to FIG. 1, with like elements being labeled in like fashion. In the illustrative embodiment of FIG. 30, the central operator 348 is shown integrated with the window fastener in a single housing 12, which, in addition to providing a mechanism that can be used to tilt and/or remove the window, can also be used in conjunction with the window fastener actuator assembly 74 and keeper mechanism 16 to secure the window frame 356 to the window sash 358, as described above. The integration of the central operator 348 with the actuator assembly 74 reduces the total number of components of the device, thus lowering the labor and cost associated with manufacturing and assembly. In some window designs, the integration of the central operator 348 with the window fastener actuator assembly 74 may also eliminate the need for additional notching on the window sash casing 358.

While the central operator 348 in FIG. 30 is shown formed integral with the window fastener, it should be understood, however, that the central operator 348 could comprise a separate unit from the window fastener, if desired. Moreover, and in some embodiments, the central operator 348 can be configured to function in windows having other types of window fasteners, or none at all. In certain embodiments, for example, the central operator 348 can be contained in a separate housing unit from the window fastener, which can be secured at another location along the edge 378 of the window sash casing 358 apart from the central operator 348. Thus, while the various embodiments herein illustrate the addition of various window fastener components, it should be understood that the central operator 348 could also be configured to function independently from such components, if desired.

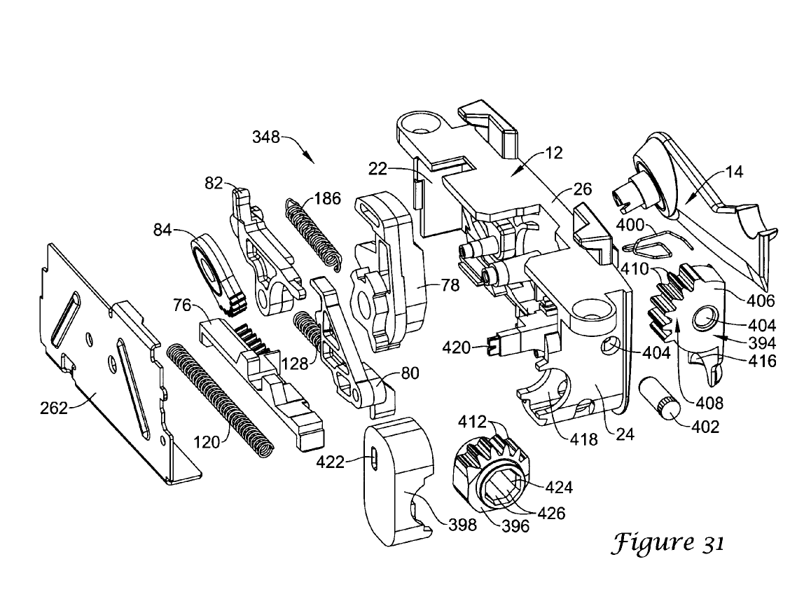

Referring now to FIG. 31, the components used in the operation of the window tilt latch mechanism 346 will now be described. As can be seen in FIG. 31, in addition to housing the various window fastener components (e.g. the slider mechanism 76, main latch 78, hook latch 80, trigger mechanism 82, etc.), the housing body 12 may further contain a tilt latch actuator assembly including a rotatable tilt latch lever 394, an idler gear 396, a retainer cap 398, and a return spring 400.

The tilt latch lever 394 can be rotatably connected to the housing body 12 via a retaining pin 402 adapted to fit within a thru-hole 404 formed in a base section 406 of the lever 394. The base section 406 of the tilt latch lever 394 may define a sector gear 408 having a number of gear teeth 410 adapted to mate with and engage a number of gear teeth 412 formed on the idler gear 396. As can be further understood by reference to both FIGS. 30 and 31, the tilt latch lever 394 may further include a handle section 414 that can be gripped by the user's fingers and actuated from an initially closed position to an open position, causing the lever 394 to tilt or swing outwardly away from the outer portion 18 of the housing body 12. In certain embodiments, for example, the tilt latch lever 394 can be fully actuated by tilting the handle section 414 outwardly at an angle of about 50° to 90°, and more specifically about 70°, providing the user with a visual indicator that the tilt latch assemblies 350,352 are in an unlocked position. Conversely, the handle section 414 can be dimensioned to lie flat or flush within a recessed section of the housing body 12 when the tilt latch lever 394 is engaged in a fully locked position. The return spring 400 can be used to maintain the tilt latch lever 394 substantially flat or flush against the outer portion 18 of the housing body 12 when the tilt latch assemblies 350,352 are engaged in the locked position.

The handle section 414 can be contoured to match the general contour or curvature of the outer portion 18 of the housing body 12. A cupped section 416 of the handle section 414 can be provided to facilitate rotation of the tilt latch lever 394 by the user. In use, the cupped section 416 allows the user to insert a finger to initiate rotation of the tilt latch ever 394 from the locked position to the unlocked position. Once the user has initiated rotation, the tilted configuration of the tilt latch lever 394 allows the user to then grip the handle section 414 to continue rotation to the unlocked position. While the use of a tilt latch lever 394 is depicted in FIGS. 30 and 31, it should be understood that other suitable mechanisms such as a push button or rotatable knob could be used to engage the tilt latch mechanism 346, if desired.

The idler gear 396 can be trapped within the interior of the housing body 12 by the retainer cap 398. Assembly of the idler gear 396 to the housing body 12 may be accomplished, for example, by inserting the idler gear 396 into a cased section 418 of the housing body 12, and then inserting the retainer cap 398 over the idler gear 396. A tab 420 extending inwardly from the housing body 12 can be configured to snap-fit within an opening 422 on the retainer cap 398, providing the installer with positive feedback that the idler gear 396 is properly attached within the housing body 12.

An opening 424 disposed through the idler gear 396 can be dimensioned to frictionally receive the rod 354. The opening 424 can include a number of internal grooves 426 corresponding to the flats 392 formed on the connecting rod 354, which act to positively translate rotational motion from the idler gear 396 to the rod 354 while also allowing the rod 354 to be inserted through the opening 424 during assembly. The gear teeth 412 on the idler gear 396 can be configured such that the rotational motion applied to the rod 354 is different from that being applied to the tilt latch lever 394. In certain embodiments, for example, the idler gear 396 can be configured to rotate the connecting rod 354 approximately 100° per a 70° rotation of the lever 394, or about a 1.4 to 1 mechanical advantage. The idler gear 396 could be configured to output other ratios, however, depending on the application.

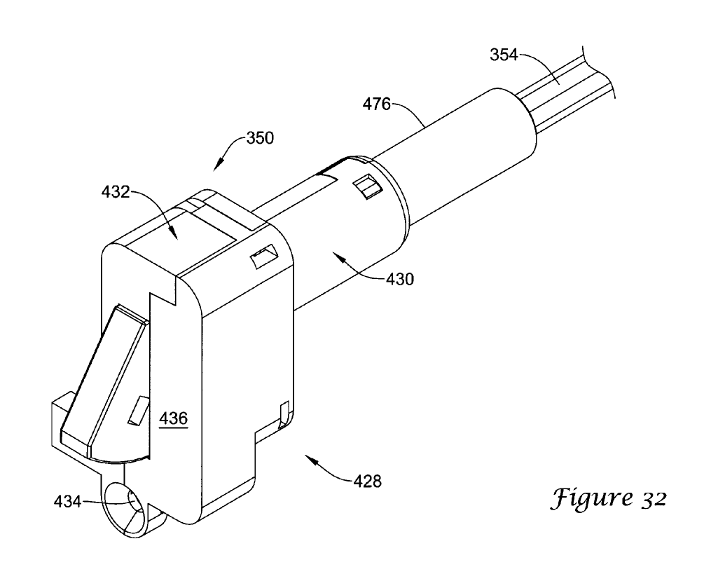

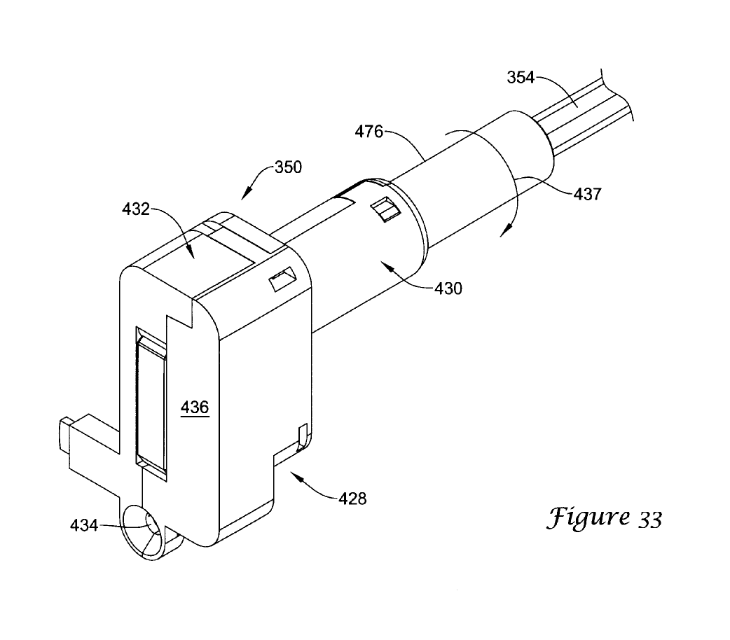

FIG. 32 is a perspective view showing the left-handed tilt latch assembly 350 of FIG. 29. As shown in FIG. 32, the tilt latch assembly 350 may include a tilt latch housing body 428 having a first section 430 adapted to receive a drive shaft that can be connected to an end of the connecting rod 354, and a second section 432 containing a mechanism that can be used to releasably secure the left side 368 of the window sash casing 358 to an adjacent window frame. A mounting hole 434 may be provided to mount the exposed side 436 of the housing body 428 substantially flush with the left side 368 of the window sash casing 358 using a screw or other suitable fastener. As shown in another view in FIG. 33, and as indicated by arrow 437, rotation of the connecting rod 354 via the central operator 348 causes the left-handed tilt latch assembly 350 to assume a second, unlocked position that that unlatches the left-handed tilt latch assembly 350 from the adjacent window frame.

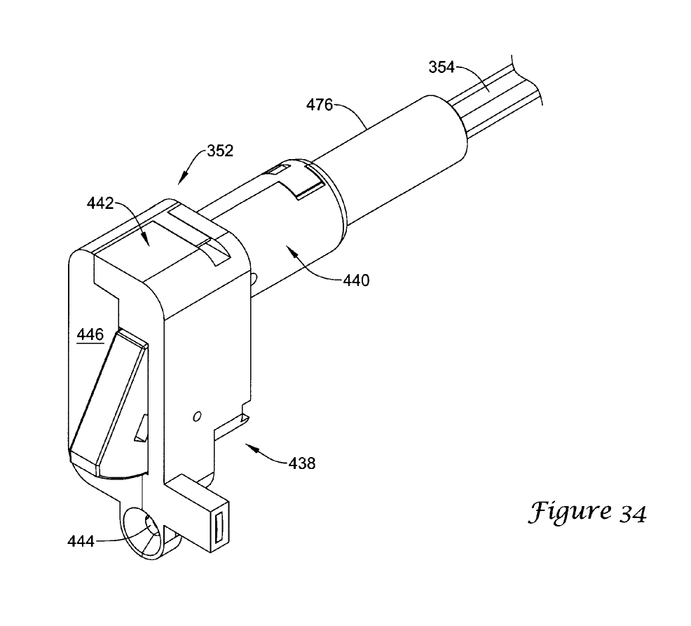

In similar fashion, and as further shown in FIG. 34, the right-handed tilt latch assembly 352 may include a tilt latch housing body 438 having a first section 440 adapted to receive a drive shaft that can be connected to the opposite end of the connecting rod 354 from the left-handed tilt latch assembly 350, and a second section 442 containing a mechanism that can be used to releasably secure the right side 370 of the window sash casing 358 to an adjacent window frame. A mounting hole 444 may be provided to mount the exposed side 446 of the housing body 438 substantially flush with the right side 370 of the window sash casing 358 using a screw or other suitable fastener. As with the left-handed tilt latch assembly 350, rotation of the connecting rod 354 via the central operator 348 causes the right-handed tilt latch assembly 352 to assume a second, unlocked position that unlatches the right-handed tilt latch assembly 352 from the adjacent window frame.

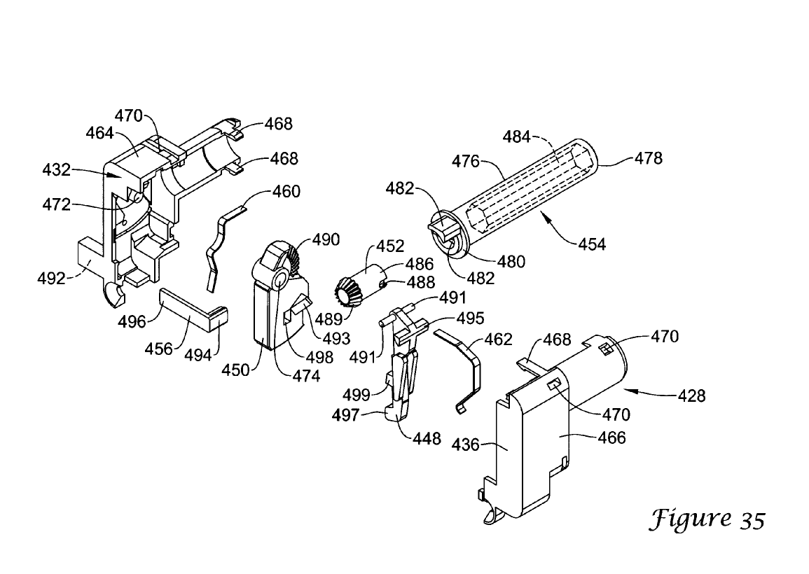

FIG. 35 is an assembly view showing the interior components of the left-handed tilt latch assembly 350 of FIG. 29. As shown in FIG. 35, the left-handed tilt latch assembly 350 may include a hook latch 448, a latch bolt 450, a drive pinion 452, a drive shaft 454, a plunger 456, and a number of lever springs 460,462. The right-handed tilt latch assembly 352 may have a configuration similar to that as the left-handed tilt latch assembly 350.

The housing body 428 may be formed from two separate halves 464,466, which can be configured to snap-fit together via a number of interlocking tabs 468 and slots 470. In use, the two halves 464,466 of the housing body 428 permit the various internal components to be assembled together in a top-down fashion, reducing assembly time and manufacturing variability. The interior of the housing body 428 may include a mounting post 472 adapted to fit within an opening 474 formed through the latch bolt 450, allowing the latch bolt 450 to pivot thereon. A number of other features such as drafts, support grooves, and thru-holes can also be provided within the interior of the housing body 428 to facilitate casing and operation of the internal components.

The drive shaft 454 can comprise an elongated tubular body 476 having a first end 478 adapted to receive an end of the connecting rod 354, and a second end 480 operatively coupled to the drive pinion 452 via a number of camming tabs 482. The tubular body 476 may define an inner channel 484 adapted to telescopically receive the end of the connecting rod 354. In some embodiments, the inner channel 484 may include a number of internal grooves adapted to frictionally receive the flats 392 formed on the connecting rod 354, allowing torque to be transferred from the rod 354 to the drive shaft 454. In use, the ability of the drive shaft 454 to telescopically receive the connecting rod 354 permits variations in the width of the window without affecting the operation of the tilt latch assembly 350. Moreover, in contrast to more conventional (e.g. push/pull) mechanisms such as linkages, cables or bands, such telescoping feature obviates the need for precise adjustment of the rod length at the time of installation or at some later point since variations in the rod length are automatically adjusted by the inner channel 484.

The drive pinion 452 can be rotatably coupled to the drive shaft 454 via a shaft 486 and tab 488 of the drive pinion 452, and can include a number of gear teeth 489 configured to mate with and engage a number of gear teeth 490 on the latch bolt 450. When the drive shaft 454 rotates, the hook latch 448 is rotated about a mounting pin 491. Such rotation of the drive shaft 454 further rotates the drive pinion 452, causing the latch bolt 450 to rotate about the mounting post 472. In certain embodiments, the drive pinion 452 may have a built-in delay feature that permits the drive pinion 452 to rotate the hook latch 448 a short distance (e.g. about 15°) before rotating the latch bolt 450. Such built-in delay feature may be provided, for example, by camming action of the camming tab 482 within the interior of the drive shaft 454, which allows the drive pinion 452 to remain in place without rotating while the hook latch 448 is rotated. In use, and as described further below, such built-in delay feature permits the hook latch 448 sufficient time to release the latch bolt 450 via a lockout tab 493 before the latch bolt 450 is rotated.

The plunger 456 can be configured to slide back and forth between a retraced or first (i.e. engaged) position and a second or extended (i.e. disengaged) position within a slot 492 formed through the first half 464 of the housing body 428. A first end 494 of the plunger 456 can be configured to contact and engage the hook latch 448 when the tilt latch assembly 350 is to disengage and the hook latch 448 is to release the latch bolt 450. A second end 496 of the plunger 456, in turn, can be configured to protrude through the first half 464 of the hosing body 428 and engage the adjacent window frame when the tilt latch assembly 350 is to disengage and the hook latch 448 is to restrict the latch bolt 450 from rotation. In contrast to the latch bolt 450, the plunger 456 is not in contact with the hook latch 448 and thus is not spring loaded when the window is closed and the tilt latch assembly 350 is engaged, which helps to reduce the formation of marks or indentations due to spring pressure of the plunger 456 against the window frame.

The hook latch 448 can be configured to restrict rotational movement of the latch bolt 450 both when the latch bolt 450 is in a fully extended position and a fully retracted position. The hook latch 448 can be activated by camming action of the tab 482 of the drive shaft 454 against a tab 495 on the hook latch 448, or by action of the first end 494 of the plunger 456 against a tab 497 of the hook latch 448, depending on whether the latch bolt 450 is to be extended or retracted (i.e. whether the window is to be opened or closed). An opening formed through the exposed side 436 of the housing body 428 can permit the latch bolt 450 to protrude outwardly from the housing body 428 when actuated back and forth by pivoting about post 472 in between the extended and retracted positions. In some embodiments, the latch bolt 450 may be under spring pressure via a lever spring 460, which acts to bias the latch bolt 450 into engagement with the drive pinion 452 and the drive shaft 454 to bias the connecting rod 354. In other embodiments, the latch bolt 450 can be configured to operate without spring pressure applied via the lever spring 460.

When engaged in its fully extended position, the latch bolt 450 can be configured to secure the window within the window frame during normal operation while also resisting picking by an intruder via the engagement of a locking tab 498 on the latch bolt 450 with a tab 499 on the hook latch 448. The latch bolt 450 can be held between a fully extended position or a fully retracted position based on rotation of the drive shaft 454 vis-à-vis the connecting rod 354, and with the tabs 499 of the hook latch 448, which contact the latch bolt 450 in either the fully extended or fully retracted positions. In some embodiments, the hook latch 448 may be under spring pressure via a second lever spring 462, which acts to bias the hook latch 448 into engagement with the latch bolt 450. In other embodiments, the hook latch 448 can be configured to operate without spring pressure applied via the lever spring 462, if desired.

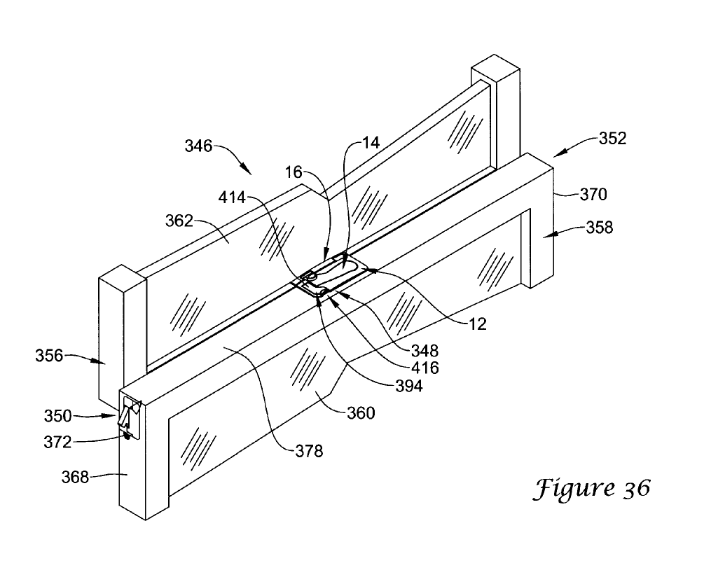

FIG. 36 is a perspective view showing the illustrative window tilt latch mechanism 346 of FIG. 29 connected to the window frame 356 and window sash casing 358. As shown in FIG. 36, the window frame 356 and window sash casing 358 can be configured to support the central operator 348 and keeper mechanism 16, respectively. The sides 368,370 of the window sash casing 358, in turn, can be configured to support the left-handed tilt latch assembly 350 and right-handed tilt latch assembly 352, respectively.

In a generally locked position in FIG. 36, the tilt latch lever 394 of the central operator 348 can be configured to align substantially flush with the exterior of the housing body 12, allowing the housing body 12 to assume a relatively low profile along the edge 378 of the window sash casing 358. In those embodiments employing an integral window fastener mechanism, and as further shown in FIG. 36, the lever 14 can similarly be configured to align substantially flush with the exterior of the main housing body 12 to maintain a low profile.

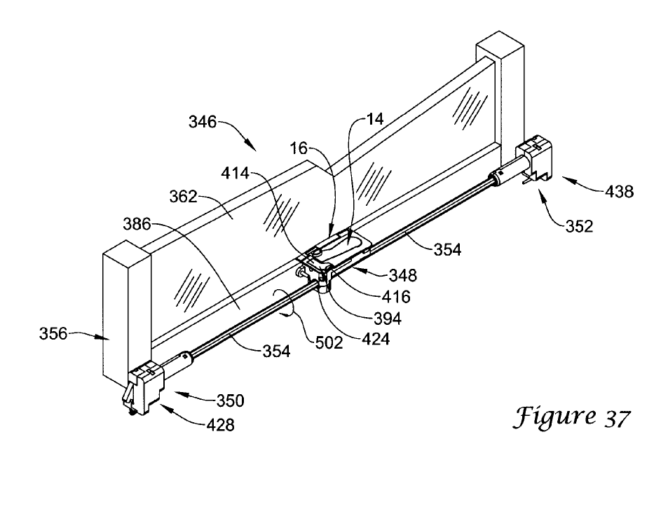

FIG. 37 is a partial perspective view of the illustrative window tilt latch mechanism 346 of FIG. 29 showing the window sash casing 358 removed to expose the connecting rod 354 and left and right-handed tilt latch assemblies 350,352. The rod 354, which is adapted to fit through a channel formed within the interior of the window sash casing 358, can extend along the length of the edge 378 operatively connecting the left-handed tilt latch assembly 350 and right-handed tilt latch assembly 352 to the central operator 348.

An illustrative method of operating of the window tilt latch mechanism 346 will now be described. From an initially locked position shown in FIG. 37, the user may insert a finger into the cupped section 416 and rotate the tilt latch lever 394 upwardly away from housing body 12. Once tilted slightly away from the housing body 12, the user may then grasp the handle section 414 and continue to rotate the tilt latch lever 394 upwardly. Rotation of the tilt latch lever 394 in this manner forces the connecting rod 354 to rotate in the direction indicated generally by arrow 502, causing each tilt latch assembly 350,352 to actuate simultaneously and in tandem from an initially locked position to an unlocked position.

As can be understood by reference to both FIGS. 35 and 37, the rotation of the connecting rod 354 via the idler gear 396 causes the drive shaft 454 for each tilt latch assembly 350,352 to engage a respective drive pinion. With respect to the left-handed tilt latch assembly 350, for example, initial rotational motion (e.g. the first 15° of motion) from the connecting rod 354 causes camming tab 482 on the second end 480 of the drive shaft 454 to engage only the hook latch 448, forcing the hook latch 448 to pivot and disengage from the lockout tab 493 on the latch bolt 450, allowing the hook latch 448 to rotate. Continued rotation of the drive shaft 454 beyond this initial rotation causes the camming tab 482 to then engage camming notch 488 of the drive pinion 452 which engages the gears on the latch bolt 450, forcing the latch bolt 450 to then rotate. The ratio of the connecting rod 354 rotation may be different from the latch bolt 450 rotation, providing a mechanical advantage that increases torque transfer from the rod 354 to the latch bolt 450. In certain embodiments, for example, the latch bolt 450 can have a 2.5 to 1 mechanical advantage wherein an approximate 85° rotation of the drive pinion 452 (as measured from the moment when the drive pinion 452 begins to engage the latch bolt 450) translates the latch bolt 450 approximately 34°, or through its full travel. A different mechanical advantage could be provided, however, to increase or decrease the torque transfer to the latch bolt 450, if desired.

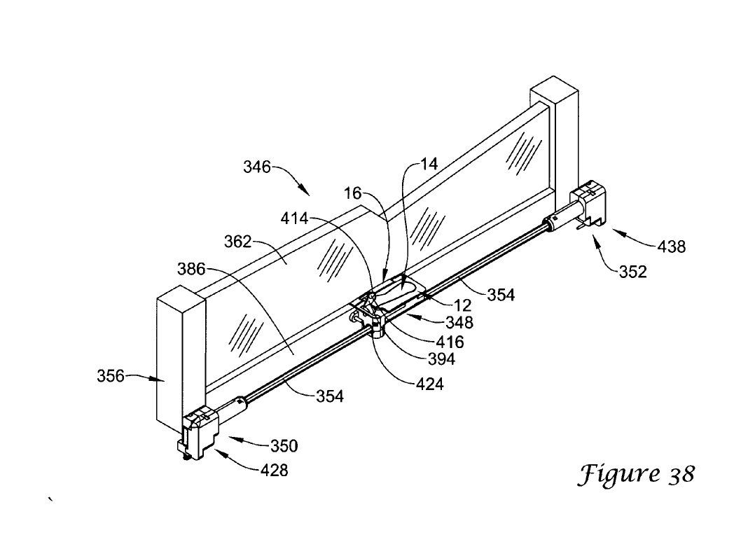

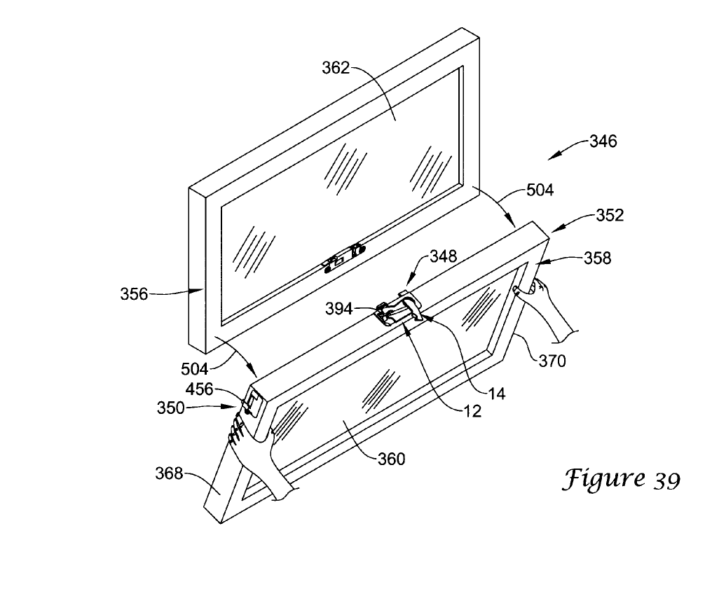

Once the latch bolt 450 is fully retracted into the housing body 428, the tab 498 on the latch bolt 450 can be configured to secure with the locking tab 499 on the hook latch 448, thereby securing the latch bolt 450 in its fully disengaged position, as shown, for example, in a second (i.e. unlocked) position in FIG. 38. In this position, the user is then free to maneuver or pivot the window panel 360 outwardly, or, if desired, remove the window panel 360 altogether. For example, as shown in another view in FIG. 39 with the tilt latch mechanism 346 in the unlocked position, the user may grip the side edges 368,370 of the window sash casing 358 with both of their hands and then pivot or tilt the window panel 360 outwardly away from the window frame 356 in the direction indicated generally by the arrows 504. Since the latch bolt 450 is maintained in the fully disengaged position by action of the tab 499 against tab 493, the user is able to freely use both hands during this process without having to maintain the tilt latch mechanism 346 in its unlocked position. In addition, and as further shown in FIG. 39, the tilt latch lever 394 and plungers 456 can be configured to protrude outwardly from the housing body 12 and respective tilt latch bodies, providing the user with visual feedback that the tilt latch mechanism 346 is in its unlocked position.

When in the pivoted or unlocked position, the tilt latch lever 394 will be positioned in an upward or tilted position via the resistance and position of the connecting rod 354, providing the user with a clear visual indicator that the window is unlatched. In some embodiments, the tilt latch lever 394 can be configured to remain in position until the plungers 456 for both tilt latch assemblies 350,352 come into contact with the window frame 356 or some other object. Such configuration allows the latch bolt 450 to remain retracted if one of the plungers 456 is inadvertently depressed. In some embodiments, and as can be seen in FIG. 35, the latch bolt 450 can be shaped as a flat paddle, with no angles working towards or away from the adjacent window frame. During operation, the shape of the latch bolt 450 may aid in reducing damage to the trim in the event the user accidentally attempts to push the window back into the frame while one or both of the latch bolts 450 are still extended.

To subsequently reset the tilt latch mechanism 346, the user with the free use of both hands may place the window panel 360 back into the normal operating position within the window frame and then push the window frame a short distance (e.g. 3/32 of an inch) further until both plungers 456 contact the window frame and are activated. If desired, the user can push in one side of the window panel 360 at a time into the window frame until both plungers 456 have been activated. Again, the tilt latch lever 394 can be configured to remain in an upward and tilted position until both plungers 456 have been activated, providing the user with a visual indicator of the status of the tilt latch mechanism 346.

Once each plunger 456 is activated, movement of the plunger 456 against the hook latch 448 causes the hook latch 448 to pivot so that the latch bolt 450, via spring pressure, is free to extend into the adjacent window frame. Typically, the latch bolts 450 for each tilt latch assembly 350,352 will not fully engage within the adjacent window frame until both plungers 456 are activated, and/or until both window frame grooves allow latch bolt 450 engagement. When both latch bolts 450 are fully engaged within the window frame, and as a result of the mechanism's gearing, the tilt latch lever 394 can be configured to reset back to its locked position, as depicted, for example, in FIG. 36.

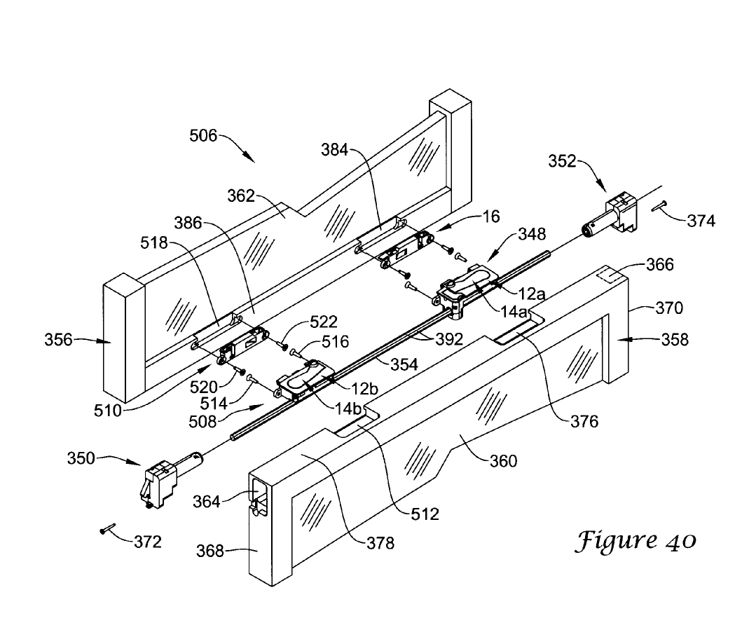

Referring now to FIG. 40, an assembly view showing an automatic window tilt latch mechanism 506 in accordance with another illustrative embodiment of the present invention having a dual tilt latch configuration will now be described. Mechanism 506 is similar to mechanism 346 described above, with like elements labeled in like fashion in the various views. In the illustrative embodiment of FIG. 40, however, the mechanism 506 may further include a second window fastener 508 and keeper mechanism 510 that can be utilized to secure the window sash casing 358 to the window frame 356 at another location separate from the central operator 348. As shown in FIG. 40, for example, the second window fastener 508 can be configured to fit within a second cutout 512 formed on the edge 378 of the window sash casing 358, and can be secured thereto using screws 514,516 or other suitable fastener. The keeper mechanism 510, in turn, can be configured to fit within a second cutout 518 formed on the edge 386 of the window frame 356 using screws 520,522 or other suitable fastener. The second window fastener 508 can be configured to function independently of the central operator 348 via a second lever 14b.

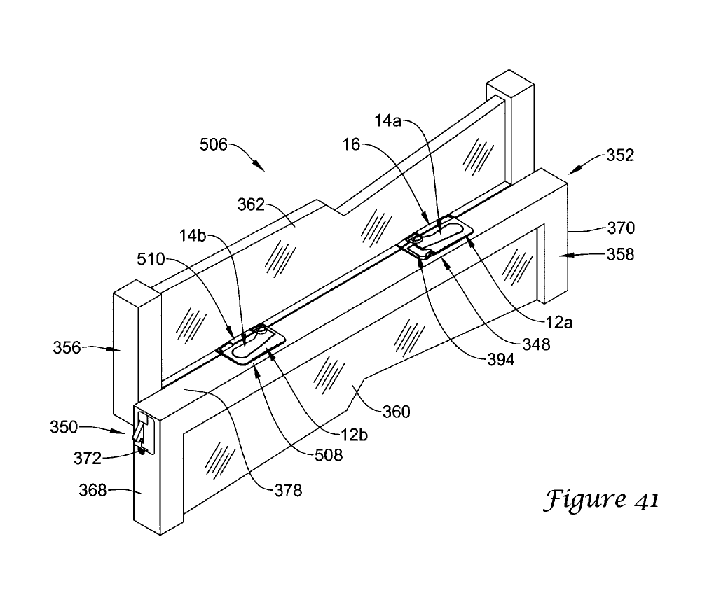

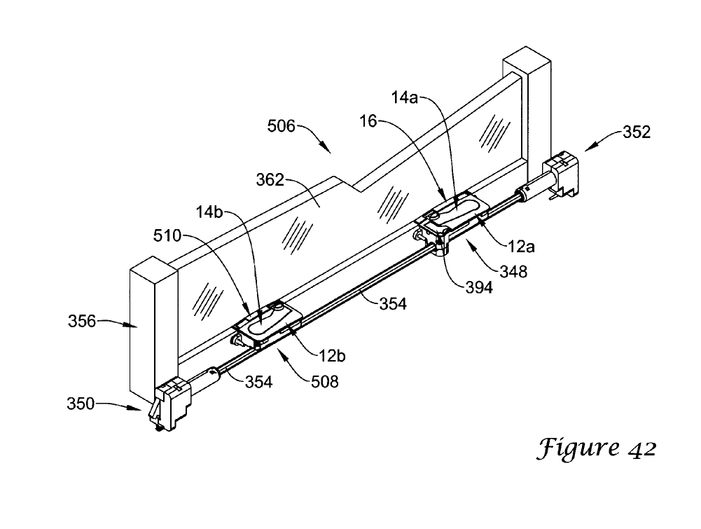

The mechanism 506 can be configured to function similar to mechanism 346 described above. As shown connected to the window frame 356 and window sash casing 358 in FIG. 41, the lever 14b of the second window fastener 508 can have an opposite (i.e. left-handed) configuration from the lever 14a on the central operator 348. As shown in another view in FIG. 42 with the window sash casing 358 removed, the connecting rod 354 can extend through the window sash casing 358 at a location spaced apart from the second window fastener 508, preventing interference between the rod 354 and the second window fastener 508.

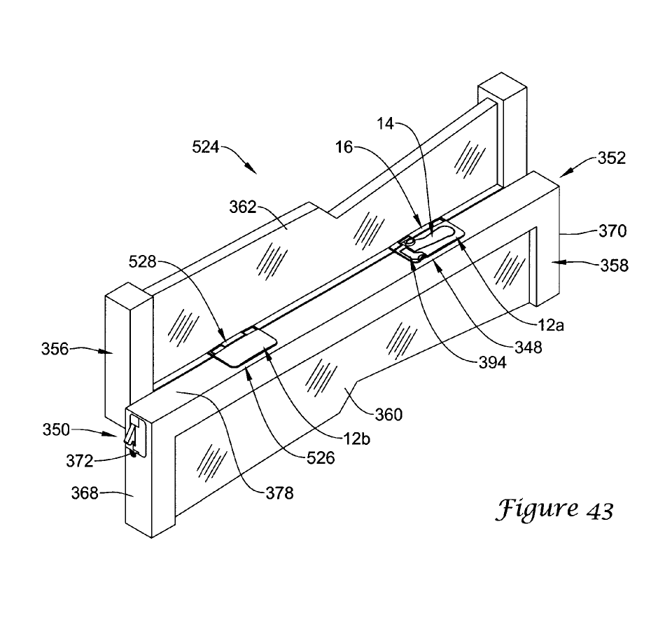

Referring now to FIG. 43, a perspective view of showing an automatic window tilt latch mechanism 524 in accordance with another illustrative embodiment of the present invention having a master-slave configuration will now be described. Mechanism 524 is similar to mechanism 346 described above, with like elements labeled in like fashion in the various views. In the illustrative embodiment of FIG. 43, however, the central operator 348 may be operatively coupled to an adjacent slave window fastener 526, which in conjunction with a second keeper mechanism 528 can be utilized to secure the window frame 356 to the window sash 358 at a second location separate from the central operator 348. In some applications, for example, the addition of the slave window fastener 526 and keeper mechanism 528 can be utilized in a relatively large window where multiple locks are specified and/or where additional security is desired.

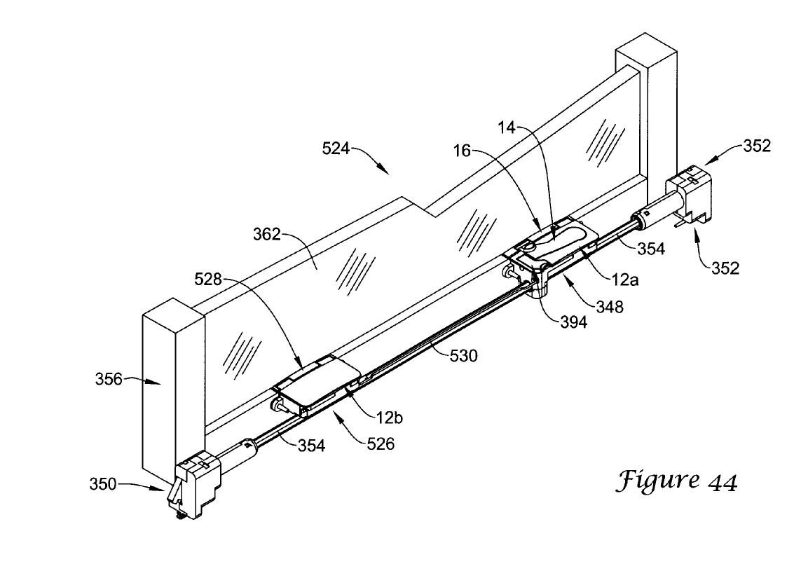

FIG. 44 is a partial perspective view of the illustrative window tilt latch mechanism of FIG. 43 showing the window sash casing 358 removed to expose the connecting rod and a linking mechanism. The window fastener portion of the central operator 348 can be operatively coupled to the slave window fastener 526 via a wire, rod, or other linking mechanism. As shown in FIG. 44, for example, a linkage 530 mechanically connecting the central operator 348 to the slave window fastener 526 can be used to translate rotational motion applied to the lever 14 to an actuator assembly disposed within the slave window fastener 526. The connecting rod 354, which is physically separated from the linkage 530 used to actuate the slave window fastener 526, can extend through the window sash casing 358 at a location spaced apart from the slave window fastener 526 and linkage 530, preventing interference between the connecting rod 354 and the slave window fastener 526.

Having thus described the several embodiments of the present invention, those of skill in the art will readily appreciate that other embodiments may be made and used which fall within the scope of the claims attached hereto. Numerous advantages of the invention covered by this document have been set forth in the foregoing description. Changes may be made in details, particular in matters of size, shape, and arrangement of parts without exceeding the scope of the invention. It will be understood that this disclosure is, in many respects, only illustrative.

What is claimed is:

1. A tilt latch mechanism for securing a window to a window frame, the tilt latch mechanism comprising:
a central operator including a tilt latch actuator assembly;
at least one tilt latch assembly actuatable between a locked position and an unlocked position; and
a rod operatively connecting the tilt latch actuator assembly to the at least one tilt latch assembly, said rod adapted to translate rotational motion from the tilt latch actuator assembly to the at least one tilt latch assembly for actuating the tilt latch assembly between said locked and unlocked positions.

2. The tilt latch mechanism of claim 1, wherein said at least one tilt latch assembly includes a first tilt latch assembly operatively coupled to a first end of the rod, and a second tilt latch assembly operatively coupled to a second end of the rod.

3. The tilt latch mechanism of claim 2, wherein the first and second tilt latch assemblies are adapted to simultaneously actuate in response to rotational motion of the rod.

4. The tilt latch mechanism of claim 1, wherein the tilt latch actuator assembly includes:
a tilt latch lever having a base section and a handle section rotatable between a first position and a second position, the base section of the tilt latch lever defining a sector gear;
a return spring adapted to bias the tilt latch lever in said first position;
an idler gear adapted to mate with and engage the sector gear, the idler gear defining an opening adapted to slidably receive the rod; and
a retainer cap adapted to secure the idler gear within an interior portion of the central operator.

5. The tilt latch mechanism of claim 4, wherein the tilt latch lever is adapted to lie substantially flat or flush with an outer portion of the central operator in said first position, and tilt outwardly away from the outer portion of the central operator in said second position.

6. The tilt latch mechanism of claim 1, wherein each tilt latch assembly includes:
a housing body;
a drive shaft having a first end adapted to receive an end of the rod, and a second end operatively coupled to a drive pinion;
a hook latch having a first tab adapted to engage the drive shaft and a second tab adapted to engage the drive pinion;
a latch bolt operatively coupled to the drive pinion and including a number of tabs adapted to engage a tab on the hook latch for selectively locking the latch bolt in an extended, locked position or a retracted, unlocked position within the housing body; and
a plunger slidably disposed within the housing body and adapted to trigger the hook latch for releasing the latch bolt.

7. The tilt latch mechanism of claim 6, further comprising a number of springs adapted to bias the hook latch and latch bolt so as to permit the latch bolt to automatically reset from its unlocked position to its locked position.

8. The tilt latch mechanism of claim 6, wherein the first end of the drive shaft defines an inner channel adapted to telescopically receive an end of the rod.

9. The tilt latch mechanism of claim 6, wherein the rod includes a number of flats formed thereon for transferring torque from the central operator to each drive shaft.

10. The tilt latch mechanism of claim 6, wherein the drive shaft includes a camming tab adapted to engage the hook latch, said camming tab configured to permit the hook latch to rotate an initial distance prior to the drive pinion engaging the latch bolt.

11. The tilt latch mechanism of claim 1, wherein the tilt latch assembly automatically actuates from the unlocked position to the locked position in response to the plunger contacting an adjacent window structure.

12. The tilt latch mechanism of claim 1, wherein, during operation, the tilt latch mechanism is adapted to permit the operator to freely grip the window with both hands when securing the window to the window frame.

13. The tilt latch mechanism of claim 1, wherein the central operator further includes a window fastener mechanism.

14. The tilt latch mechanism of claim 13, wherein the window fastener mechanism includes:
a lever actuatable between a first position and a second position;
a window fastener actuator assembly operatively coupled to the lever and actuatable between an unlocked position and a locked position; and
a keeper mechanism.

15. The tilt latch mechanism of claim 14, wherein the window fastener actuator assembly includes:
a lever gear;
a main latch engageable between a first latch position and a second latch position, the main latch including a base section and a clasp section;
a hook latch including a camming tab adapted to engage the main latch;
a slider mechanism operatively coupled to the lever gear and adapted to actuate the main latch between the first latch position and second latch position; and
a trigger mechanism.

16. The tilt latch mechanism of claim 1, wherein said window is a single-hung window.

17. The tilt latch mechanism of claim 1, wherein said window is a double-hung window.

18. The tilt latch mechanism of claim 1, wherein said window is a swinging or casement window.

19. A tilt latch mechanism for securing a window to a window frame, the tilt latch mechanism comprising:
a central operator including a tilt latch actuator assembly, the tilt latch actuator assembly including:
a tilt latch lever rotatable between a first position and a second position; and
an idler gear operatively coupled to the tilt latch lever;
a pair of tilt latch assemblies each actuatable between a locked position and an unlocked position; and
a rod operatively connecting the tilt latch actuator assembly to each of the tilt latch assemblies, said rod adapted to simultaneously translate rotational motion from the idler gear to the pair of tilt latch assemblies for actuating each tilt latch assembly between said locked and unlocked positions.

20. A tilt latch mechanism for securing a window to a window frame, the tilt latch mechanism comprising:
a central operator including a tilt latch actuator assembly;
a pair of tilt latch assemblies each actuatable between a locked position and an unlocked position, each tilt latch assembly including:
a housing body;
a drive shaft having a first end adapted to receive an end of a rod, and a second end operatively coupled to a drive pinion;
a hook latch having a first tab adapted to engage the drive shaft and a second tab adapted to engage the drive pinion;
a latch bolt operatively coupled to the drive pinion and including a number of notches adapted to engage a tab on the hook latch for selectively locking the latch bolt in an extended, locked position or a retracted, unlocked position within the housing body; and
a plunger slidably disposed within the housing body and adapted to trigger the hook latch for releasing the latch bolt; and
wherein said rod is adapted to simultaneously translate rotational motion from the tilt latch actuator assembly to the pair of tilt latch assemblies for actuating each tilt latch assembly between said locked and unlocked positions.

21. A combined window fastener and tilt latch system for use with a window having a window sash and a window frame, the system comprising:
a central operator coupled to the window sash, the central operator including a tilt latch actuator assembly and a window fastener actuator assembly;
a keeper mechanism coupled to the window frame;
at least one tilt latch assembly coupled to the window sash; and
a means for connecting the tilt latch actuator assembly to said at least one tilt latch assembly.

22. The system of claim 21, further comprising at least one additional window fastener.

23. The system of claim 22, wherein said at least one additional window fastener is operatively coupled to the central operator.

24. The system of claim 22, wherein said at least one additional window fastener comprises a slave window fastener operatively coupled to the central operator via a linking mechanism.

25. The system of claim 22, wherein said at least one addition widow fastener is a stand-alone unit.

26. The system of claim 21, wherein the central operator includes a first lever operatively coupled to the tilt latch actuator assembly, and a second lever operatively coupled to the window fastener actuator assembly.

27. The system of claim 21, wherein said tilt latch actuator assembly and window fastener actuator assembly are contained in a single housing body.

28. The system of claim 21, wherein said means for connecting the tilt latch actuator assembly to said at least one tilt latch mechanism comprises a rod including a number of flats thereon.

29. The system of claim 21, wherein said at least one tilt latch assembly comprises a pair of tilt latch assemblies each adapted to simultaneously actuate by rotational motion of the rod.
